(19) United States
(12) Patent Application Publication
(10) Pub. No.: US 2009/0174969 A1
(43) Pub. Date: Jul. 9, 2009

(54) MAGNETIC RECORDING MEDIUM, MAGNETIC SIGNAL REPRODUCTION SYSTEM AND MAGNETIC SIGNAL REPRODUCTION METHOD

(75) Inventors: Toshio Tada, Kanagawa (JP); Takeshi Harasawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, TOKYO (JP)

(21) Appl. No.: 12/295,460

(22) PCT Filed: Mar. 30, 2007
(86) PCT No.: PCT/JP2007/057297

§ 371 Date: Sep. 30, 2008

(30) Foreign Application Priority Data
Mar. 31, 2006 (JP) 2006-099940

(51) Int. Cl. G11B 5/33

(52) U.S. Cl. 360/324; G9B/5.104

(57) ABSTRACT

The present invention relates to a magnetic recording medium comprising a magnetic layer comprising a ferromagnetic powder and a binder on a nonmagnetic support, wherein the magnetic layer has a thickness δ ranging from 10 to 80 nm, a product, Mrδ, of a residual magnetization Mr of the magnetic layer and the thickness δ of the magnetic layer is equal to or greater than 1 mA but less than 5 mA, a ratio, Sdc/Sac, of an average area Sdc of magnetic clusters in a DC demagnetized state to an average area Sac of magnetic clusters in an AC demagnetized state as measured by a magnetic force microscope, MFM, ranges from 0.8 to 2.0.

### CROSS-REFERENCE TO RELATED APPLICATIONS

This application claims the benefit of priority to Japanese Patent Application No. 2006-099940 filed on Mar. 31, 2006, which is expressly incorporated herein by reference in its entirety.

### TECHNICAL FIELD

The present invention relates to a magnetic recording medium, and more specifically, to a magnetic recording medium suited to ultra-high-density digital recording, affording good electromagnetic characteristics with highly sensitive MR heads such as highly sensitive anisotropic magnetoresistive (AMR) heads and giant magnetoresistive (GMR) heads, particularly a magnetic recording medium suited to reproduction with GMR heads. Still further, the present invention relates to a magnetic signal reproduction method and magnetic signal reproduction system employing the above magnetic reproduction medium.

### BACKGROUND TECHNIQUE

In recent years, means for rapidly transmitting information at the terabyte level have undergone marked development. It has become possible to transmit data and images comprising huge amounts of information, while demand for advanced technology to record, reproduce, and store them has developed. Examples of recording and reproduction media include flexible disks, magnetic drums, hard disks, and magnetic tapes. Especially, the recording capacity of each reel of a magnetic tape is large, and such tapes play major roles, such as in data backup.

In recent years, the track width of magnetic tapes has narrowed as the density has risen, and the trend has been toward shorter recording wavelengths. Thus, the use of magnetoresistive heads (referred to as “MR heads” hereinafter), which are more sensitive than the inductive heads that have been widely employed as reproduction heads in magnetic recording and reproduction systems, has been proposed for reproduction and put into practice.

When the residual magnetization per unit area of the magnetic layer becomes excessively high, the MR head becomes saturated. Thus, different characteristics are required of media employed with MR heads than are required of conventional media employed with inductive heads. Since MR heads are highly sensitive, it is required to smoothen the magnetic surface by means of microgranular magnetic powders for the reduction of medium noize. In response, for example, it has been proposed that the magnetic layer be made 0.01 to 0.3 μm in thickness and the residual magnetization per unit area of the magnetic layer be made 5 to 50 mA to prevent saturation of the MR head, and that a roughness of specific spatial frequency be specified to reduce modulation noise (see Japanese Unexamined Patent Publication (KOKAI) No. 2001-256633 (“Reference 1” hereinafter), which is expressly incorporated herein by reference in its entirety); that the ratio between the thickness of the magnetic layer and the minimum bit length be controlled and that nonmagnetic powder be added to the magnetic layer to a volume fill rate of 15 to 35 percent of the magnetic layer to reduce noise while preventing MR head saturation (see Japanese Unexamined Patent Publication (KOKAI) No. 2002-92846 (“Reference 2” hereinafter), which is expressly incorporated herein by reference in its entirety; and that both the residual magnetization per unit area of the magnetic layer, and the ratio of the average area Sdc of magnetic clusters in a DC demagnetized state to the average area Sac of magnetic clusters in an AC demagnetized state as measured by a magnetic force microscope (MFM), be controlled to enhance the electromagnetic characteristics in an MR head (see Japanese Unexamined Patent Publication (KOKAI) No. 2004-103186 (“Reference 3” hereinafter), which is expressly incorporated herein by reference in its entirety). A large amount of analytic research relating to the medium noise caused by magnetic particle chain and loop aggregation is also being conducted (see J. Hokkyo, “Theory of Microparticle-type Recording Media and Separation and Estimation Methods for Noise Sources,” Journal of the Magnetics Society of Japan, 1997, Vol. 21, No. 4-1, pp. 149-159 (“Reference 4” hereinafter), and P. Luo, H. N. Bertram, “Tape Medium Noise Measurements and Analysis,” IEEE Transactions on Magnetics (U.S.), 2001, Vol. 37, No. 4, pp. 1620-1623 (“Reference 5” hereinafter), which are expressly incorporated herein by reference in their entirety).

Noise due to surface roughness can be reduced by the technique described in Reference 1. The volume fill rate of magnetic powder can be reduced to reduce magnetostatic interaction by the technique described in Reference 2. However, these techniques present a problem in that nonmagnetic powder and magnetic powder tend to aggregate, and thus are not necessarily adequate in terms of the uniformity of distribution of magnetic particles in the magnetic layer that is required for noise reduction.

References 4 and 5 merely present estimations based on mathematical computation, and do not propose specific medium parameters or methods for controlling them.

Numerous proposals have been made for enhancing dispersion, including the above-cited techniques. However, none has successfully enhanced the microstructure of the magnetic layer.

The MR heads that are currently generally employed in hard disk drives, flexible disk systems, and backup tape systems are anisotropic magnetoresistive heads (AMR heads). Reference 3 proposes that to achieve good electromagnetic characteristics in an MR head, the lower limit of residual magnetization per unit area of the magnetic layer be specified at 5 mA, permitting adequate reproduction output in AMR heads, and that by enhancing dispersion, the ratio (Sdc/Sac) of the average area Sdc of magnetic clusters in a DC demagnetized state to the average area Sac of magnetic clusters in an AC demagnetized state as measured by a magnetic force microscope (MFM) be set to from 0.8 to 2.0.

By contrast, giant magnetoresistive heads (GMR heads) utilizing the giant magnetoresistive effect have been developed in recent years. GMR heads have already been put to practical use in hard disk drives, and their application to flexible disk systems and backup tape systems is being discussed. GMR heads permit a threefold or greater improvement in reading sensitivity over AMR heads, for example. Further, AMR heads have achieved higher sensitivity since Reference 3 was filed. With such highly sensitive MR heads, adequate reproduction output can be ensured even at a residual magnetization (Mrδ) per unit area of the magnetization layer of less than 5 mA, obtained by multiplying the residual magnetization per unit area, Mr, with the thickness of the magnetic layer, δ.

Additionally, the present inventors conducted an investigation resulting in the discovery that keeping the value of Mrδ low over the range ensuring reproduction output effectively enhanced the S/N ratio during high-density recording. This was thought to occur because when the value of Mrδ was increased (to 5 mA or above, for example), the half-width of the isolated waveform broadened and waveform interference increased at a high linear recording density exceeding 100 kfci, for example, resulting in a drop in output and increased noise during high-density recording. Thus, it is required to reduce Mrδ to achieve a high S/N ratio during high-density recording. To prevent increased noise and decreased output due to head saturation, it is desirable to reduce Mrδ.

Accordingly, the present inventors considered how to reduce Mrδ to achieve a high S/N ratio in a high-density recording region. As understood from the fact that the residual magnetization per unit area of the magnetic layer is obtained as (Mrδ) by multiplying the residual magnetization per unit area, Mr, by the thickness of the magnetic layer, δ, one means of reducing Mrδ is to reduce the thickness of the magnetic layer. To achieve even higher density recording, it is advantageous to reduce the thickness of the magnetic layer. Thus, the present inventors examined application of the technique of Reference 3 to a magnetic recording medium in which Mrδ was lowered by reducing the thickness of the magnetic layer.

Reference 3 discloses that by imparting a strong shear after coating and orientation, clusters that have reaggregated due to orientation are effectively broken up. However, based on an examination, the present inventors discovered that even when this technique was employed, the thickness of the magnetic layer was reduced, and Mrδ was lowered, there were still times when it was difficult to reduce noise (raise the S/N ratio).

### DISCLOSURE OF THE INVENTION

Accordingly, it is an object of the present invention to provide a magnetic recording medium with a thin magnetic layer that affords a good S/N ratio during reproduction with highly sensitive MR heads such as highly sensitive AMR heads and GMR heads.

The present inventors conducted extensive research into achieving the above-stated object. As a result, they discovered that in a magnetic recording medium in which the thickness of the magnetic layer had been reduced to achieve an Mrδ of less than 5 mA, the above-stated object was achieved by increasing the dispersion of the magnetic layer to keep the value of Sdc/Sac described above to within a range of 0.8 to 2.0. The present invention was devised on that basis.

That is, the above-stated object was achieved by the following means:

[1] A magnetic recording medium comprising a magnetic layer comprising a ferromagnetic powder and a binder on a nonmagnetic support, wherein

the magnetic layer has a thickness δ ranging from 10 to 80 nm,

a product, Mrδ, of a residual magnetization Mr of the magnetic layer and the thickness δ of the magnetic layer is equal to or greater than 1 mA but less than 5 mA, and

a ratio, Sdc/Sac, of an average area Sdc of magnetic clusters in a DC demagnetized state to an average area Sac of magnetic clusters in an AC demagnetized state as measured by a magnetic force microscope, MFM, ranges from 0.8 to 2.0.

[2] The magnetic recording medium according to [1], wherein the ferromagnetic powder is a hexagonal ferrite powder.
[3] The magnetic recording medium according to [2], wherein the hexagonal ferrite powder has an average plate diameter ranging from 10 to 45 nm and an average plate ratio ranging from 1.5 to 4.5.
[4] The magnetic recording medium according to [1], wherein the ferromagnetic powder is an iron nitride powder.
[5] The magnetic recording medium according to [4], wherein the iron nitride powder has an average particle diameter ranging from 5 to 30 nm.
[6] The magnetic recording medium according to any of [1] to [5], which is employed in a magnetic signal reproduction system employing a giant magnetoresistive magnetic head as a reproduction head.
[7] A magnetic signal reproduction system, comprising:

the magnetic recording medium according to any of [1] to [5], and

a reproduction head.

[8] The magnetic signal reproduction system according to [7], wherein

the reproduction head is a giant magnetoresistive magnetic head.

[9] A magnetic signal reproduction method, reproducing magnetic signals that have been recorded on the magnetic recording medium according to any of [1] to [5] with a reproduction head.
[10] The magnetic signal reproduction method according to [9], wherein the reproduction head is a giant magnetoresistive magnetic head.

The present invention can provide a magnetic recording medium affording good electromagnetic characteristics with highly sensitive MR heads such as highly sensitive AMR heads and GMR heads, that is suited to high-density digital recording, affords an adequate reduction in noise, and achieves an adequate S/N ratio.

### BEST MODE FOR CARRYING OUT THE INVENTION

### Magnetic Recording Medium

The magnetic recording medium of the present invention is a magnetic recording medium comprising a magnetic layer comprising a ferromagnetic powder and a binder on a nonmagnetic support, wherein the magnetic layer has a thickness δ ranging from 10 to 80 nm, a product, Mrδ, of a residual magnetization Mr of the magnetic layer and the thickness δ of the magnetic layer is equal to or greater than 1 mA but less than 5 mA, and a ratio, Sdc/Sac, of an average area Sdc of magnetic clusters in a DC demagnetized state to an average area Sac of magnetic clusters in an AC demagnetized state as measured by a magnetic force microscope, MFM, ranges from 0.8 to 2.0.

In the detailed description of the magnetic recording medium of the present invention, the “magnetic cluster area ratio” will be described first.

It is widely known that in theory, low noise is achieved by a high fill ratio of microgranular magnetic particles. However, in particular, when microgranular magnetic particles are employed, there is a problem that the magnetic particles aggregate, creating entities that behave like single large magnetic material and compromise the S/N ratio. The present inventors employed a magnetic force microscope (MFM) to measure magnetic blocks (referred to as “magnetic clusters” hereinafter), discovering that the magnetic clusters correlated with medium noise and varied with the aggregation and magnetostatic bonding of the magnetic particles. A more detailed description will be given below.

The magnetic force microscope (MFM) permits the observation of leakage magnetic fields in minute spaces with a resolution of several tens of nanometers. That is, the magnetic force microscope (MFM) affords the feature of permitting the measurement of the state of magnetization of a magnetic recording medium at the submicron level. Generally, while applying an alternating magnetic field to a sample, the magnetic field is weakened stepwise to eliminate magnetization of the sample in what is known as alternating current (AC) demagnetization. Generally, individual magnetic materials will randomly orient themselves, total magnetization will approach zero, and the individual magnetic particles will exist in a nearly primary particle state while in an alternating current (AC) demagnetized state. Accordingly, magnetic clusters in an alternating current (AC) demagnetized state exhibit a nearly constant size, irrespective of the state of dispersion, that depends on the type of magnetic material (the size of the primary particle of the magnetic material and the saturation magnetization σs of the magnetic material) in the case of a magnetic particle medium.

Additionally, the method of applying a direct current and reducing the magnetic field to zero is called direct current (DC) demagnetization. In a direct current (DC) demagnetized state, residual magnetic fields within the sample is a combination of magnetization in the same orientation as the magnetic field that has been applied. Accordingly, the size of magnetic clusters in a direct current (DC) demagnetized state varies based on how magnetic particles are disposed within the medium, that is, based on their dispersion state. When an aggregate is present, it can be thought of as appearing to act as a single large magnetic particle. The size of magnetic clusters in a direct current (DC) demagnetized state corresponds to the size of the aggregates appearing to act as single large magnetic particles.

In an ideal state of dispersion, the aggregates would also disappear in a DC demagnetization state, and the magnetic clusters would be of the same size in both AC and DC demagnetized states. The larger the magnetic clusters in a DC demagnetized state relative to the size of the magnetic clusters in an AC demagnetized state, the greater the aggregation of the magnetic particles in the magnetic layer. That is, the value of Sdc/Sac serves as an indicator of the state of aggregation of magnetic particles in the magnetic layer.

Information on the aggregation state (dispersion) of the magnetic layer can also be obtained from just the size of the magnetic clusters in a DC magnetized state. However, for example, take a medium (sample α) in which A denotes the average area of the magnetic clusters in an AC demagnetized state and B denotes the average area of the magnetic clusters in a DC demagnetized state, and a medium (sample β) in which the average area of the magnetic clusters in an AC demagnetized state is 2A (=twice that in sample α), but in which the dispersion is increased to a higher level than in sample a to inhibit aggregation, resulting in an average area of magnetic clusters in a DC demagnetized state of B, just as in sample α. A comparison of just the average area Sdc of magnetic clusters in a DC demagnetized state would yield the same value for both, despite the dispersion state of sample β actually being superior. That is, the area of magnetic clusters in a DC demagnetized state can change with the type of magnetic material, such as the size of the magnetic material.

By contrast, Sdc/Sac in sample α would be “B/A,” and Sdc/Sac in sample β would be “B/2A,” with the Sdc/Sac of sample β being ½ that of sample α.

By adopting the ratio of Sdc/Sac in this manner, when the Sdc of two samples is identical despite different states of dispersion, a difference occurs due to the difference in dispersion. That is, taking the ratio of Sdc/Sac affords an indicator of the standardized aggregation state (dispersion) that is not affected by the type of magnetic material.

Based on the above knowledge, the present inventors conducted extensive research into the correlation between the ratio (Sdc/Sac) of the average area Sdc of magnetic clusters in a DC demagnetized state to the average area Sac of magnetic clusters in an AC demagnetized state and the S/N ratio. This resulted in the discovery that a good S/N ratio was achieved when Sdc/Sac fell within the range of 0.8 to 2.0. Thus, in the present invention, Sdc/Sac is set to within the range of 0.8 to 2.0. At above 2.0, noise increases and a good S/N ratio cannot be achieved. In the case of an ideal dispersion state, Sac and Sdc would match and Sdc/Sac would become 1. Thus, the closer Sdc/Sac is to 1, the closer the state is to no aggregation. However, since the magnetic cluster size is measured by a magnetic force microscope (MFM) and there is some measurement error, when this measurement error is taken into account, the lower limit essentially becomes 0.8. The above ratio is desirably 0.8 to 1.7, preferably 0.8 to 1.5.

The magnetic recording medium of the present invention comprises a magnetic layer with a thickness of 10 to 80 nm. When the magnetic layer is less than 10 nm in thickness, it becomes difficult to ensure a residual magnetization level (Mrδ) with the required range of equal to or greater than 1 mA but less than 5 mA. Further, even coating of the magnetic layer becomes difficult, resulting in recording layer nonuniformity. The effect of the surface properties of the nonmagnetic support or nonmagnetic layer that is positioned beneath the magnetic layer tends to roughen the magnetic layer surface and compromise electromagnetic characteristics. Generally, the recording depth, assuming the depth of the magnetic recording signal to be semicircular, is about ¼ the recording wavelength. However, in reality, due to the effect of spacing loss, the recordable depth is reduced to about ⅙ to ⅛ the recording wavelength. Thus, when the thickness of the recording layer exceeds 80 nm, during high-density recording, at a high linear recording density exceeding 100 kfci (λ=500 nm) for example, portions that are not recorded in the direction of recording depth increase and noise increases. Thus, in the magnetic recording medium of the present invention, the thickness of the magnetic layer is set to equal to or less than 80 nm, desirably to within a range of 30 to 80 nm.

In the magnetic recording medium of the present invention, Mrδ, which is the product of the residual magnetization Mr in the magnetic layer and the thickness δ of the magnetic layer, is equal to or greater than 1 mA but less than 5 mA. Mrδ, a value indicating the residual magnetization per unit area of the magnetic layer, can be measured with a vibrating sample fluxmeter made by Toei Industry Co., for example. When the Mrδ of the magnetic layer is less than 1 mA, magnetization is inadequate in reproduction with a highly sensitive MR head, and it is difficult to achieve adequate reproduction output. When Mrδ is equal to or greater than 5 mA, the half-width of the isolated waveform broadens, waveform interference increases at high linear recording densities, for example, exceeding 100 kfci, output decreases, and noise increases. It also causes saturation of the magnetoresistive elements of the head. As a result, the waveform is distorted, output becomes saturated, and noise increases. In some cases, there is also a risk of damaging the magnetoresistive elements. Mrδ is desirably 1 to 4.8 mA, preferably ranging from 2 to 4 mA.

Mrδ can be controlled by means of the magnetic layer thickness and squareness. Specifically, an Mrδ of equal to greater than 1 mA but less than 5 mA can be achieved by keeping the magnetic layer to within a thickness range of 10 to 80 nm and the squareness to within a range of 0.3 to 0.9. Controlling the strength of the orienting magnetic field and drying conditions and controlling the level of dispersion of the coating liquid are examples of methods for achieving the desired squareness.

As set forth above, the average area Sac of magnetic clusters in an AC demagnetized state is determined by the diameter of the primary magnetic particles, and the average area Sdc of magnetic clusters in a DC demagnetized state basically depends on the dispersion of the magnetic particles and dispersion stability. Both Sdc and Sac are desirably within a range of 3,000 to 50,000 nm², preferably a range of 3,000 to 35,000 nm², and more preferably, within a range of 3,000 to 20,000 nm². When both Sdc and Sac are equal to or greater than 3,000 nm, magnetization is not destabilized by thermal fluctuation, and when equal to or less than 50,000 nm², a small unit of reversal of magnetization and a high resolution can be achieved during high-density recording.

Since Sdc can vary with the dispersibility of the magnetic layer, it is possible to achieve a desired Sdc/Sac by controlling the Sdc value by means of the dispersibility of the magnetic layer. However, in thin magnetic layers 10 to 80 nm in thickness, it is sometimes difficult to increase the dispersibility of the magnetic layer to a degree yielding an Sdc/Sac within a range of 0.8 to 2.0 by just the technique described in Japanese Unexamined Patent Publication (KOKAI) No. 2004-103186, for example. This is because, in thin magnetic layers, there are cases in which reaggregation cannot be prevented during drying by simply imparting a shear following orientation, as is described in Japanese Unexamined Patent Publication (KOKAI) No. 2004-103186. This became clear to the present inventors upon investigation. By contrast, in the present invention, dispersing the magnetic particles to a high degree and stabilizing them, and maintaining a stable state of dispersion in the coating step or breaking up reaggregation occurring during the coating step, it is possible to achieve an Sdc/Sac within the above-stated range. Specific methods of achieving this will be described below.

A binder of good dispersibility is desirably adsorbed onto the microgranular magnetic material to achieve a high degree of dispersion of the magnetic particles and stabilize them. A binder with good compatibility with solvents is desirably employed. For example, a binder comprising polyurethane with an inertial radius in cyclohexanone of 5 to 25 nm is desirably employed. The specifics are given in Japanese Unexamined Patent Publication (KOKAI) Heisei No. 9-27115. The content of the above publication is expressly incorporated herein by reference in its entirety. The binder affords dispersion stability in small quantities, permitting enhanced dispersibility and an enhanced volume fill rate.

To break up the reaggregation occurring during the coating step, imparting a strong shear following coating orientation is effective at breaking up clusters that have reaggregated due to orientation, as is described in Japanese Unexamined Patent Publication (KOKAI) No. 2004-103186. To impart a shear following orientation, a smoother can be used, for example. The term “smoother” means a rigid body (sheetlike or rod-shaped) with a smooth surface that is brought into contact with the surface of the magnetic layer while in a wet state to impart a strong shearing force. The rigid body employed is desirably polished to a mirror finish affording a surface roughness Ra of equal to or less than 2 nm. The shearing force is a function of the coating liquid viscosity, coating speed, and coating thickness, and can be optimized based on the objective.

When applying the present invention to a magnetic recording medium of multilayer structure, the method of coating the magnetic layer after the nonmagnetic layer has dried (wet-on-dry) is desirably employed to inhibit aggregation and lower the Sdc. In the case of multilayer coating while both the magnetic layer and nonmagnetic layer are still wet (wet-on-wet), to prevent a decrease in the electromagnetic characteristics or the like of the magnetic recording medium due to aggregation of magnetic particles, the imparting of a shear to the coating liquid within the coating head by the method disclosed in Japanese Unexamined Patent Publication (KOKAI) Showa No. 62-95174 or Japanese Unexamined Patent Publication (KOKAI) Heisei No. 1-236968 is desirable. The contents of the above publications are expressly incorporated herein by reference in their entirety.

The following problems have been encountered in inhibiting aggregation in a magnetic layer 10 to 80 nm in thickness.

To achieve a magnetic layer with a thickness δ of 10 to 80 nm, generally either (1) the quantity of coating liquid applied during coating is reduced, or (2) the liquid concentration is reduced. In particular, when employing the wet-on-dry method, at a magnetic layer thickness ranging from 10 to 80 nm, rapid drying during drying in (1) tends to cause aggregation in the magnetic layer, and lowering the liquid concentration by adding a large quantity of solvent in (2) destabilizes the liquid itself, lengthens the drying time, and tends to cause the magnetic material to aggregate. Even when a smoother is used to apply a shear following orientation and break down the aggregate, an active surface results, which is thought to end up causing reaggregation during drying. Since the problem of reaggregation occurs during drying when the thickness of the magnetic layer is reduced, as described above, it is sometimes difficult to inhibit aggregation in a thin magnetic layer to a degree yielding an Sdc/Sac falling within the above-stated range.

By contrast, as a result of investigation, the present inventors discovered that reaggregation during drying was inhibited by controlling the particle size distribution of the magnetic particles in the magnetic layer. This was attributed to the fact that when magnetic particles of relative large diameter are included in large number among the magnetic particles, they serve as nuclei for reaggregation. Accordingly, processing is desirably conducted prior to coating to achieve a uniform particle size distribution of the magnetic particles in the coating liquid, and particles serving as nuclei for reaggregation following drying are desirably removed. In the case of hexagonal ferrite, the particle size distribution of the magnetic particles is desirably controlled so that the hexagonal ferrite powder contained in the magnetic layer has a particle size distribution such that the diameter of particles constituting 95 percent of the cumulative volume (referred to as “D95” hereinafter) is equal to or less than 70 nm (preferably equal to or less than 65 nm, more preferably falling within a range of 10 to 60 nm). In the case of iron nitride powder, the particle size distribution of the magnetic particles is desirably controlled so that the iron nitride powder contained in the magnetic layer has a particle size distribution such that D95 is equal to or less than 80 nm (preferably equal to or less than 75 nm, more preferably falling within a range of 5 to 70 nm). That is, the magnetic layer of the magnetic recording medium of the present invention is desirably a layer that is formed by coating and drying a magnetic layer coating liquid having a particle size distribution within the above-stated range on a nonmagnetic support or nonmagnetic layer.

Kneading the magnetic layer coating liquid in an open kneader, dispersing it in a sand mill using zirconia beads, and then subjecting it to a grading process is effective in controlling the particle size distribution. The grading process can be conducted with a centrifugal separator.

The magnetic recording medium of the present invention will be described in greater detail below.

Nonmagnetic Support

A known film in the form of a polyester such as polyethylene terephthalate or polyethylene naphthalate, polyolefins, cellulose triacetate, polycarbonate, polyamide, polyimide, polyamidoimide, polysulfone, polyaramide, aromatic polyamide, or polybenzooxazole can be employed as the nonmagnetic support. The use of a high-strength support such as polyethylene naphthalate or polyamide is desirable. As needed, laminated supports such as those disclosed in Japanese Unexamined Patent Publication (KOKAI) Heisei No. 3-224127 can be employed to vary the surface roughness of the magnetic surface and base surface. The content of the above publication is expressly incorporated herein by reference in its entirety. These supports can be corona discharge treated, plasma treated, treated to facilitate adhesion, heat treated, treated to remove dust, or the like in advance. An aluminum or glass substrate can also be employed as the support in the present invention.

Of these, a polyester support (referred to simply as “polyester” hereinafter) is desirable. The polyester is desirably comprised of dicarboxylic acid and a diol, such as polyethylene terephthalate and polyethylene naphthalate.

Examples of the dicarboxylic acid component serving as the main structural component are: terephthalic acid, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylethane dicarboxylic acid, cyclohexane dicarboxylic acid, diphenyl dicarboxylic acid, diphenylthioether dicarboxylic acid, diphenylketone dicarboxylic acid, and phenylindane dicarboxylic acid.

Examples of the diol component are: ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenolfluorene dihydroxyethyl ether, diethylene glycol, neopentyl glycol, hydroquinone, and cyclohexanediol.

Among polyesters employing these compounds as main structural components, those comprising main structural components in the form of a dicarboxylic acid component in the form of terephthalic acid and/or 2,6-naphthalene dicarboxylic acid, and a diol component in the form of ethylene glycol and/or 1,4-cyclohexane dimethanol, are desirable from the perspectives of transparency, mechanical strength, dimensional stability, and the like.

Among these, polyesters comprising main structural components in the form of polyethylene terephthalate or polethylene-2,6-naphthalate; copolymer polyesters comprised of terephthalic acid, 2,6-naphthalene dicarboxylic acid, and ethylene glycol; and polyesters comprising main structural components in the form of mixtures of two or more of these polyesters are preferred. Polyesters comprising polyethylene-2,6-naphthalate as the main structural component are of even greater preference.

The polyester may be biaxially oriented, and may be a laminate with two or more layers.

Other copolymer components may be copolymerized and other polyesters may be mixed into the polyester. Examples are the dicarboxylic acid components and diol components given above by way of example, and polyesters comprised of them.

To help prevent delamination when used in films, aromatic dicarboxylic acids having sulfonate groups or ester-forming derivatives thereof, dicarboxylic acids having polyoxyalkylene groups or ester-forming derivatives thereof, diols having polyoxyalkylene groups, or the like can be copolymerized in the polyester.

Among these, 5-sodiumsulfoisophthalic acid, 2-sodiumsulfoterephthalic acid, 4-sodiumsulfophthalic acid, 4-sodiumsulfo-2,6-naphthylene dicarboxylic acid, compounds in which the sodium in these compounds has been replaced with another metal (such as potassium or lithium), ammonium salt, phosphonium salt, or the like, ester-forming compounds thereof, polyethylene glycol, polytetramethylene glycol, polyethylene glycol-polypropylene glycol copolymers, compounds in which the two terminal hydroxy groups of these compounds have been oxidized or the like to form carboxyl groups, and the like are desirable from the perspectives of the polyester polymerization reaction and film transparency. The ratio of copolymerization to achieve this end is desirably 0.1 to 10 mol percent based on the dicarboxylic acid constituting the polyester.

Further, to increase heat resistance, a bisphenol compound or a compound having a naphthalene ring or cyclohexane ring can be copolymerized. The copolymerization ratio of these compounds is desirably 1 to 20 mol percent based on the dicarboxylic acid constituting the polyester.

The above polyesters can be manufactured according to conventional known polyester manufacturing methods. An example is the direct esterification method, in which the dicarboxylic acid component is directly esterification reacted with the diol component. It is also possible to employ a transesterification method in which a dialkyl ester is first employed as a dicarboxylic acid component to conduct a transesterification reaction with a diol component, and the product is then heated under reduced pressure to remove the excess diol component and conduct polymerization. In this process, transesterification catalysts and polymerization catalysts may be employed and heat-resistant stabilizers added as needed.

One or more of various additives such as anticoloring agents, oxidation inhibitors, crystal nucleus agents, slipping agents, stabilizers, antiblocking agents, UV absorbents, viscosity-regulating agents, defoaming transparency-promoting agents, antistatic agents, pH-regulating agents, dyes, pigments, and reaction-stopping agents can be added at any step during synthesis.

Filler can be added to the support. Examples of fillers are: inorganic powders such as spherical silica, colloidal silica, titanium oxide, and alumina, and organic fillers such as crosslinked polystyrene and silicone resin.

Further, to render the supports highly rigid, these materials can be highly oriented, and surface layers of metals, semimetals, and oxides thereof can be provided.

The nonmagnetic support is desirably 3 to 80 micrometers, preferably 3 to 50 micrometers, and more preferably, 3 to 10 micrometers in thickness. The center surface average roughness (Ra) of the support surface is desirably equal to or less than 6 nm, preferably equal to or less than 4 nm. Ra is a value that is measured with an HD2000 made by WYKO.

Further, the Young's modulus of the nonmagnetic support is desirably equal to or greater than 6.0 GPa, preferably equal to or greater than 7.0 GPa, in the longitudinal and width directions.

The magnetic recording medium of the present invention comprises a magnetic layer comprising a ferromagnetic powder and a binder on at least one surface of the nonmagnetic support. A nonmagnetic layer (lower layer) is desirably present between the nonmagnetic support and the magnetic layer.

Magnetic Layer

Examples of the ferromagnetic powder contained in the magnetic layer are: ferromagnetic metal powders, hexagonal ferrite powder, and iron nitride powder. The tendency of ferromagnetic powder to aggregate, which affects the average area Sdc of the magnetic cluster size in a DC demagnetized state, depends particularly on the saturation magnetization σs and shape in terms of ferromagnetic powder characteristics. The lower the σs, the less magnetostatic interaction and the lower the tendency to aggregate, or the greater the tendency for aggregation to be broken up. Thus, hexagonal ferrite powder, which facilitates the obtaining of a low σs, is desirable, relative to the ferromagnetic metal powder. In terms of shape, the lower the ratio of the major axis length to the minor axis length of an acicular magnetic material, that is the aspect ratio, the easier it is to break up aggregation (magnetic particles tend to become entangled with each other and then disentangle). From this perspective, a spherical shape is desirable. Iron nitride, which does not have shape anisotropy but has crystal anisotropy and is readily prepared as a spherical magnetic material, is desirable.

(i) Hexagonal Ferrite Powder

Hexagonal ferrite powder with a volume of 1,000 to 20,000 nm³ is desirable, and such powder with a volume of 2,000 to 8,000 nm³ is preferred. Within this range, it is possible to effectively inhibit a decrease in magnetic characteristics due to thermal fluctuation and obtain a good C/N(S/N) ratio while maintaining low noise.

The above volume is a value that is calculated from the plate diameter and axial length (plate thickness) when a hexagonal columnar shape is envisioned for hexagonal ferrite powder.

The average size of the ferromagnetic powder can be calculated by the following method. A suitable quantity of the magnetic layer is peeled off. To 30 to 70 mg of the magnetic layer that has been peeled off is added n-butylamine, the mixture is sealed in a glass tube, and the glass tube is placed in a thermal decomposition device. The glass tube is then heated for about a day at 140° C. After cooling, the contents are recovered from the glass tube and centrifugally separated to separate the liquid from the solid component. The solid component that has been separated is cleaned with acetone to obtain a powder sample for a transmission electron microscope (TEM). The particles in this sample are photographed at a magnification of 100.000-fold with a model H-9000 transmission electron microscope made by Hitachi and printed on photographic paper at a total magnification of 500,000-fold to obtain particle photographs. The targeted magnetic material is selected from the particle photographs, the contours of the powder material are traced with a digitizer, and the size of the particles is measured with KS-400 image analyzer software from Carl Zeiss. The size of 500 particles is measured and the measured values are averaged to obtain the average size.

Examples of hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

The particle size of the ferromagnetic ferrite powder is, as an average plate diameter, preferably 10 to 45 nm, more preferably a size with the above-described volume. At an average plate diameter of equal to or greater than 10 nm, the amount of magnetic materials involving in recording due to thermal fluctuation can be readily ensured even when the particle size distribution is considered. At an average plate diameter of equal to or less than 40 nm, high output and low noise can be ensured at high linear recording density. The average plate diameter of the hexagonal ferrite powder preferably ranges from 10 to 40 nm, more preferably 15 to 40 nm, further preferably 20 to 30 nm.

An average plate ratio [average of (plate diameter/plate thickness)] of the hexagonal ferrite powder preferably ranges from 1.5 to 4.5, more preferably 2 to 3. When the average plate ratio ranges from 1.5 to 4.5, adequate orientation can be achieved while maintaining high filling property in the magnetic layer, increased noise due to stacking between particles can be suppressed, and the magnetic recording medium with excellent durability can be obtained. The specific surface area by BET method (SBET) within the above particle size range is preferably equal to or higher than 40 m²/g, more preferably 40 to 200 m²/g, and particularly preferably, 60 to 100 m²/g.

Narrow distributions of particle plate diameter and plate thickness of the hexagonal ferrite powder are normally good. About 500 particles can be randomly measured in a transmission electron microscope (TEM) photograph of particles to measure and compare the particle plate diameter and plate thickness. The distributions of particle plate diameter and plate thickness are often not a normal distribution. However, when expressed as the standard deviation to the average size, σ/average size is 0.1 to 1.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known.

A coercivity (Hc) of the hexagonal ferrite powder of 143.3 to 318.5 kA/m (1800 to 4,000 Oe) can normally be achieved. The coercivity (Hc) of the hexagonal ferrite powder preferably ranges from 159.2 to 238.9 kA/m (2,000 to 3,000 Oe), more preferably 191.0 to 214.9 kA/m (2,200 to 2,800 Oe). The coercivity (Hc) can be controlled by particle size (plate diameter and plate thickness), the types and quantities of elements contained, substitution sites of the element, the particle producing reaction conditions, and the like.

The saturation magnetization (σₛ) of the hexagonal ferrite powder preferably ranges from 30 to 80 A·m²/kg (30 to 80 emu/g). The higher saturation magnetization (σₛ) is preferred, however, it tends to decrease with decreasing particle size. Known methods of improving saturation magnetization (σₛ) are combining spinel ferrite with magnetoplumbite ferrite, selection of the type and quantity of elements incorporated, and the like. It is also possible to employ W-type hexagonal ferrite. When dispersing the magnetic material, the particle surface of the magnetic material can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added normally range from 0.1 to 10 mass percent relative to the mass of the magnetic material. The pH of the magnetic material is also important to dispersion. A pH of about 4 to 12 is usually optimum for the dispersion medium and polymer. From the perspective of the chemical stability and storage properties of the medium, a pH of about 6 to 11 is preferable. Moisture contained in the magnetic material also affects dispersion. There is an optimum level for the dispersion medium and polymer, usually selected from the range of 0.01 to 2.0 percent.

Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. Any manufacturing method can be selected in the present invention. As needed, the hexagonal ferrite powder can be surface treated with Al, Si, P, or an oxide thereof. The quantity can be set to 0.1 to 10 mass percent of the hexagonal ferrite powder. When applying a surface treatment, the quantity of a lubricant such as a fatty acid that is adsorbed is desirably not greater than 100 mg/m². The hexagonal ferrite powder will sometimes contain inorganic ions such as soluble Na, Ca, Fe, Ni, or Sr. These are desirably substantially not present, but seldom affect characteristics at equal to or less than 200 ppm.

(ii) Iron Nitride Powder

In the present invention, the term “iron nitride powder” means magnetic powder containing at least an Fe₁₆N₂ phase. Iron nitride phases other than the Fe₁₆N₂ phase are not desirably present. This is because, although the crystal magnetic anisotropy of iron nitride (Fe₄N and Fe₃N phases) is about 1×10⁵ erg/cc (1×10⁻² J/cc), Fe₁₆N₂ has a high crystal magnetic anisotropy of 2×10⁶ to 7×10⁶ erg/cc (2×10⁻¹ to 7×10⁻¹ J/cc). Thus, high coercivity can be maintained even with microparticles. This high crystal magnetic anisotropy is due to the crystalline structure of the Fe₁₆N₂ phase. The crystalline structure is a body-centered square crystal with N atoms inserted at regular positions within an octahedral lattice of Fe. The distortion caused by the introduction of N atoms into the lattice is thought to be the causative factor behind the high crystal magnetic anisotropy. The easy axis of magnetization of the Fe₁₆N₂ phase is the C axis extended due to conversion to a nitride.

The shape of the particles containing the Fe₁₆N₂ phase is desirably granular or elliptic. Spherical is preferred. This is because, of the three equivalent directions of α-Fe, which is a cubic crystal, one is selected by conversion to a nitride to serve as the c axis (easy axis of magnetization). If the particle shape were to be acicular, the easy axis of magnetization would be the short axis direction, with particles in the major axis direction being undesirably mixed in. Accordingly, the average value of the aspect ratio of the major axis length/minor axis length is equal to or less than 2 (1 to 2, for example), preferably equal to or less than 1.5 (1 to 1.5, for example).

Generally, the particle diameter is determined by the diameter of the iron particle prior to conversion to a nitride, and is preferably a monodispersion. This is because, in general, medium noise drops in a monodispersion. The particle diameter of the iron nitride magnetic powder having Fe₁₆N₂ as main phase is normally determined by the particle diameter of the iron particles. The particle diameter distribution of the iron particles is desirably a monodispersion. This is because the nitride ratio differs in large particles and small particles, and the magnetic characteristics differ. For this reason as well, the particle diameter distribution of iron nitride magnetic powder is desirably a monodispersion.

The average particle diameter of the iron nitride is desirably 5 to 30 nm, preferably 5 to 25 nm, more preferably, 8 to 15 nm, and still more preferably, 9 to 11 nm. This is because a small particle diameter results in a large thermal fluctuation effect, causing super paramagnetism that is unsuited to a magnetic recording medium. Due to magnetic viscosity, the coercivity increases during high-speed recording in the head, making it hard to record. On the other hand, when the particle diameter increases, it becomes impossible to decrease the saturation magnetization, causing the coercivity to become excessively high during recording and making it difficult to record. When the particles are large, noise due to particles increases when employed in a magnetic recording medium. The average particle diameter of the iron nitride in the present invention refers to the average particle diameter of the Fe₁₆N₂ phase. When a layer is formed on the surface of Fe₁₆N₂ particles, it refers to the average size of the Fe₁₆N₂ particles without the layer. A layer such as an oxidation inhibiting layer can be optionally formed on the surface of the Fe₁₆N₂ particles.

The particle diameter distribution of the iron nitride is desirably a monodispersion. This is because medium noise generally decreases in a monodispersion. The coefficient of variation of the particle diameter is equal to or less than 15 percent (desirably 2 to 15 percent), preferably equal to or less than 10 percent (desirably 2 to 10 percent). The particle diameter and the coefficient of variation of the particle diameter can be calculated by placing and drying diluted alloy nanoparticles on a Cu 200 mesh on which a carbon film has been adhered, shooting a negative at 100.000-fold magnification by TEM (1200EX made by JEOL), measuring the negative with a particle diameter measuring device (KS-300 made by Carl Zeiss), and calculating the values from the arithmetic average particle diameter measured.

The content of nitrogen relative to iron in the particles contained in the Fe₁₆N₂ phase is desirably 1.0 to 20.0 atomic percent, preferably 5.0 to 18.0 atomic percent, and more preferably, 8.0 to 15.0 atomic percent. This is because when the amount of nitrogen becomes excessively low, the quantity of Fe₁₆N₂ phase that forms decreases. An increase in coercivity is caused by the distortion due to conversion to a nitride. When the quantity of nitrogen becomes excessively low, coercivity decreases. When too much nitrogen is present, the Fe₁₆N₂ phase becomes a semistable phase, becoming other nitrides that are stable phases when decomposed. As a result, the saturation magnetization decreases excessively.

In the present invention, the term “coefficient of variation of the particle diameter” means the value that is obtained by calculating the standard deviation of the particle diameter distribution for the equivalent circular diameter, and dividing it by the average particle diameter. The term “coefficient of variation of the composition” means the value that is obtained by calculating the standard deviation of the composition distribution of alloy nanoparticles in the same manner as for the coefficient of variation of the particle diameter, and dividing it by the average composition. Such values are multiplied by 100 and indicated as percentages in the present invention.

The average particle diameter and the coefficient of variation in the particle diameter can be calculated by placing and drying diluted alloy nanoparticles on a Cu 200 mesh on which a carbon film has been adhered, shooting a negative at 100.000-fold magnification by TEM (1200EX made by JEOL), measuring the negative with a particle diameter measuring device (KS-300 made by Carl Zeiss), and calculating the values from the arithmetic average particle diameter measured.

The surface of the iron nitride powder comprising the main phase of the Fe₁₆N₂ is desirably covered with an oxide film. This is because Fe₁₆N₂ microparticles oxidize readily and require handling in a nitrogen atmosphere.

The oxide film desirably contains rare earth elements and/or elements selected from among silicon and aluminum. Thus, the same particle surface as the conventional metal particles with main components in the form of iron and Co is present, with high compatibility with the steps for handling metal particles. Y, La, Ce, Pr, Nd, Sm, Tb, Dy, and Gd are desirably employed as the rare earth elements, with the use of Y being preferred from the perspective of dispersibility.

Further, in addition to silicon and aluminum, boron and phosphorus can be incorporated as needed. Further, carbon, calcium, magnesium, zirconium, barium, strontium, and the like can be incorporated as effective elements. The use of these other elements with rare earth elements and/or silicon and aluminum can result in better shape retention and dispersion.

In the composition of the surface compound layer, the total content of rare earth elements or boron, silicon, aluminum or phosphorus relative to iron is desirably 0.1 to 40.0 atomic percent, preferably 1.0 to 30.0 atomic percent, and more preferably, 3.0 to 25.0 atomic percent. When the quantity of these elements is excessively low, formation of the surface compound layer becomes difficult. Not only does the magnetic anisotropy of the magnetic powder decrease, but oxidation stabilization tends to deteriorate. When the quantity of these elements is excessively high, the saturation magnetization tends to drop excessively.

The oxide film is desirably 1 to 5 nm, preferably 2 to 3 nm, in thickness. When it falls below this range, oxidation stabilization tends to decrease. When too thick, the particle size sometimes tends not to substantially decrease.

As a magnetic characteristic of the iron nitride powder comprising the main phase of Fe₁₆N₂, the coercivity (Hc) is desirably 79.6 to 318.4 kA/m (1,000 to 4,000 Oe), preferably 159.2 to 278.6 kA/m (2,000 to 3,500 Oe), and more preferably, 197.5 to 237 kA/m (2,500 to 3,000 Oe). This is because when the Hc is low, in the case of in-plane recording, for example, a given bit tends to be affected by bits recorded adjacent to it, sometimes compromising suitability to high recording density. When too high, recording becomes difficult.

The “Ms·V” of the iron nitride powder is desirably 5.2×10⁻¹⁶ to 6.5×10⁻¹⁶. The saturation magnetization Ms in the “Ms·V” can be measured using a vibrating magnetic measuring apparatus (VSM), for example. The volume V can be calculated by observing the particles by a transmission electron microscope (TEM), calculating the particle diameter of the Fe₁₆N₂ phase, and converting it to a volume.

The saturation magnetization of the iron nitride powder is desirably 80 to 160 Am²/kg (80 to 160 emu/g), preferably 80 to 120 μm²/kg (80 to 120 emu/g). This is because when too low, the signal sometimes becomes excessively weak, and when too high, in the case of in-plane recording, for example, a given bit tends to affect the bits recorded adjacent to it, compromising suitability to high recording density. A squareness of 0.6 to 0.9 is desirable.

In the iron nitride powder, the BET specific surface area is desirably 40 to 100 m²/g. This is because when the BET specific surface area is excessively low, the particle size increases, noise due to particles increases when applied to the magnetic recording medium, the surface smoothness of the magnetic layer decreases, and reproduction output tends to drop. When the BET specific surface area is excessively high, the particles comprising the Fe₁₆N₂ phase tend to aggregate, it becomes difficult to obtain a uniform dispersion, and it becomes difficult to obtain a smooth surface.

Iron nitride suitable for use in the present invention can be synthesized by known methods, and may be obtained as a commercial product. Reference can be made to Japanese Unexamined Patent Publication (KOKAI) No. 2007-36183 or the like for details on iron nitride suitable for use in the present invention. The content of the above publication is expressly incorporated herein by reference in its entirety.

Binder

Known techniques for magnetic layers and nonmagnetic layers can be used for the binder, lubricants, dispersing agents, additives, solvents, dispersion methods, and the like of the magnetic layer and nonmagnetic layer in the magnetic recording medium. In particular, known techniques for magnetic layers can be applied to the quantity of binder, type of binder, and quantities and types of additives and dispersing agents added.

As set forth above, it is desirable to employ the binder described in Japanese Unexamined Patent Publication (KOKAI) Heisei No. 9-27115 in the magnetic layer to enhance dispersibility. The content of the above publication is expressly incorporated herein by reference in its entirety. Further, conventionally known thermoplastic resins, thermosetting resins, reactive resins, and mixtures thereof can be employed as the binder. Examples of thermoplastic resins are those with a glass transition temperature of −100 to 150° C., a number average molecular weight of 1,000 to 200,000, preferably 10,000 to 100,000, and a degree of polymerization of about 50 to 1,000.

Examples thereof are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten. It is also possible to employ known electron beam-cured resins in each layer. Examples and manufacturing methods of such resins are described in Japanese Unexamined Patent Publication (KOKAI) Showa No. 62-256219. The contents of the above publications are expressly incorporated herein by reference in their entirety. The above-listed resins may be used singly or in combination. Preferred resins are combinations of polyurethane resin and at least one member selected from the group consisting of vinyl chloride resin, vinyl chloride-vinyl acetate copolymers, vinyl chloride-vinyl acetate-vinyl alcohol copolymers, and vinyl chloride-vinyl acetate-maleic anhydride copolymers, as well as combinations of the same with polyisocyanate.

Polyurethane resins may be employed, such as those having a known structure such as a polyester polyurethane, polyether polyurethane, polyether polyester polyurethane, polycarbonate polyurethane, polyester polycarbonate polyurethane, and polycaprolactone polyurethane.

A binder obtained by incorporating as needed one or more polar groups selected from among —COOM, —SO₃M, —OSO₃M, —P═O(OM)₂, and —O—P═O(OM)₂ (where M denotes a hydrogen atom or an alkali metal base), —OH, —NR₂, —N⁺R₃ (where R denotes a hydrocarbon group), epoxy group, —SH, and —CN into any of the above-listed binders by copolymerization or addition reaction to improve dispersion properties and durability is desirably employed. The quantity of such a polar group preferably ranges from 10⁻¹ to 10⁻⁸ mol/g, more preferably from 10⁻² to 10⁻⁶ mol/g.

Specific examples of these binders are VAGH, VYHH, VMCH, VAGF, VAGD, VROH, VYES, VYNC, VMCC, XYHL, XYSCI PKHH, PKHJ, PKHC, and PKFE from Union Carbide Corporation; MPR-TA, MPR-TA5, MPR-TAL, MPR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, MR555, and 400×−110A from Nippon Zeon Co., Ltd.; Nippollan N2301, N2302, and N2304 from Nippon Polyurethane Co., Ltd.; Pandex T-5105, T-R3080, T-5201, Burnock D-400, D-210-80, Crisvon 6109, and 7209 from Dainippon Ink and Chemicals Incorporated.; Vylon UR8200, UR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

The quantity of binder employed in the magnetic layer and the nonmagnetic layer ranges from, for example, 5 to 50 mass percent, preferably from 10 to 30 mass percent, relative to the nonmagnetic powder or magnetic powder. When employing vinyl chloride resin, the quantity added is preferably from 5 to 30 mass percent; when employing polyurethane resin, from 2 to 20 mass percent; and when employing polyisocyanate, from 2 to 20 mass percent. They are preferably employed in combination. However, for example, when head corrosion occurs due to the release of trace amounts of chlorine, polyurethane alone or just polyurethane and isocyanate may be employed. When polyurethane is employed, preferable polyurethanes are those having a glass transition temperature ranging from −50 to 150° C., preferably from 0 to 100° C.; a elongation at break preferably ranging from 100 to 2,000 percent; a stress at break ranging from 0.05 to 10 kg/mm² (0.49 to 98 MPa); and a yield point ranging from 0.05 to 10 kg/mm² (0.49 to 98 MPa).

Examples of polyisocyanates employed in the present invention are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used in each layer singly or in combinations of two or more by exploiting differences in curing reactivity.

Additives may be added to the magnetic layer as needed. Examples of such additives are: abrasives, lubricants, dispersing agents, dispersing adjuvants, antifungal agents, antistatic agents, oxidation inhibitors, solvents, and carbon black. Examples of additives are: molybdenum disulfide, tungsten disulfide, graphite, boron nitride, graphite fluoride, silicone oil, polar group-comprising silicone, fatty acid-modified silicone, fluorosilicone, fluoroalcohols, fluoroesters, polyolefin, polyglycol, polyphenyl ether, phenyl phosphonic acid, benzyl phosphonic acid, phenethyl phosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluoylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, nonylphenylphosphonic acid, other aromatic ring-comprising organic phosphonic acids, alkali metal salts thereof, octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, isoeicosylphosphonic acid, other alkyl phosphonoic acid, alkali metal salts thereof, phenyl phosphoric acid, benzyl phosphoric acid, phenethyl phosphoric acid, α-methylbenzylphosphoric acid, 1-methyl-1-phenethylphosphoric acid, diphenylmethylphosphoric acid, diphenyl phosphoric acid, benzylphenyl phosphoric acid, α-cumyl phosphoric acid, toluoyl phosphoric acid, xylyl phosphoric acid, ethylphenyl phosphoric acid, cumenyl phosphoric acid, propylphenyl phosphoric acid, butylphenyl phosphoric acid, heptylphenyl phosphoric acid, octylphenyl phosphoric acid, nonylphenyl phosphoric acid, other aromatic phosphoric esters, alkali metal salts thereof, octyl phosphoric acid, 2-ethylhexylphosphoric acid, isooctyl phosphoric acid, isononyl phosphoric acid, isodecyl phosphoric acid, isoundecyl phosphoric acid, isododecyl phosphoric acid, isohexadecyl phosphoric acid, isooctyldecyl phosphoric acid, isoeicosyl phosphoric acid, other alkyl ester phosphoric acids, alkali metal salts thereof, alkylsulfonic acid ester, alkali metal salts thereof, fluorine-containing alkyl sulfuric acid esters, alkali metal salts thereof, lauric acid, myristic acid, palmitic acid, stearic acid, behenic acid, butyl stearate, oleic acid, linolic acid, linoleic acid, elaidic acid, erucic acid, other monobasic fatty acids comprising 10 to 24 carbon atoms (which may contain an unsaturated bond or be branched), metal salts thereof, butyl stearate, octyl stearate, amyl stearate, isooctyl stearate, octyl myristate, butyl laurate, butoxyethyl stearate, anhydrosorbitan monostearate, anhydrosorbitan tristearate, other monofatty esters, difatty esters, or polyfatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 22 carbon atoms (which may contain an unsaturated bond or be branched), alkoxyalcohol having 12 to 22 carbon atoms (which may contain an unsaturated bond or be branched) or a monoalkyl ether of an alkylene oxide polymer, fatty acid amides with 2 to 22 carbon atoms, and aliphatic amines with 8 to 22 carbon atoms. Compounds having aralkyl groups, aryl groups, or alkyl groups substituted with groups other than hydrocarbon groups, such as nitro groups, F; Cl, Br, CF₃, CCl₃, CBr₃, and other halogen-containing hydrocarbons in addition to the above hydrocarbon groups, may also be employed.

It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.).

The above-described lubricants, antistatic agents and the like need not be 100 percent pure and may contain impurities, such as isomers, unreacted material, by-products, decomposition products, and oxides in addition to the main components. These impurities are preferably comprised equal to or less than 30 mass percent, and more preferably equal to or less than 10 mass percent.

Specific examples of these additives are: NAA-102, hydrogenated castor oil fatty acid, NAA-42, Cation SA, Nymeen L-201, Nonion E-208, Anon BF and Anon LG manufactured by NOF Corporation; FAL-205 and FAL-123 manufactured by Takemoto Oil & Fat Co., Ltd.; NJLUB OL manufactured by New Japan Chemical Co. Ltd.; TA-3 manufactured by Shin-Etsu Chemical Co. Ltd.; Amide P manufactured by Lion Corporation; Duomine TDO manufactured by Lion Corporation; BA-41 G manufactured by Nisshin OilliO, Ltd.; and Profan 2012E, Newpole PE61 and Ionet MS-400 manufactured by Sanyo Chemical Industries, Ltd.

Carbon black may be added to the magnetic layer as needed. Examples of types of carbon black that are suitable for use in the magnetic layer are: furnace black for rubber, thermal for rubber, black for coloring, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 percent, and the tap density is 0.1 to 1 g/ml.

Specific examples of carbon black are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Ketjen Black International Co., Ltd. The carbon black employed may be surface-treated with a dispersant or grafted with resin, or have a partially graphite-treated surface. The carbon black may be dispersed in advance into the binder prior to addition to the magnetic coating liquid. These carbon blacks may be used singly or in combination. When employing carbon black, the quantity preferably ranges from 0.1 to 30 mass percent with respect to the mass of the ferromagnetic powder. In the magnetic layer, carbon black can work to prevent static, reduce the coefficient of friction, impart light-blocking properties, enhance film strength, and the like; the properties vary with the type of carbon black employed. Accordingly, the type, quantity, and combination of carbon blacks employed in the present invention may be determined separately for the magnetic layer and the nonmagnetic layer based on the objective and the various characteristics stated above, such as particle size, oil absorption capacity, electrical conductivity, and pH, and be optimized for each layer. For example, the Carbon Black Handbook compiled by the Carbon Black Association may be consulted for types of carbon black suitable for use in the present invention.

Abrasive

Known materials chiefly having a Mohs' hardness of equal to or greater than 6 may be employed either singly or in combination as abrasives. These include: α-alumina with an α-conversion rate of equal to or greater than 90 percent, β-alumina, silicon carbide, chromium oxide, cerium oxide, α-iron oxide, corundum, synthetic diamond, silicon nitride, silicon carbide titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 percent. The particle size of the abrasive is preferably 0.01 to 2 micrometers. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 2 g/cc, the moisture content is 0.1 to 5 percent, the pH is 2 to 11, and the specific surface area is 1 to 30 m²/g. The shape of the abrasive employed in the present invention may be acicular, spherical, cubic, plate-shaped or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co., Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd. These abrasives may be added as needed to the nonmagnetic layer. Addition of abrasives to the nonmagnetic layer can be done to control surface shape, control how the abrasive protrudes, and the like. The particle diameter and quantity of the abrasives added to the magnetic layer and nonmagnetic layer should be set to optimal values.

Known organic solvents can be used. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane; these may be employed in any ratio.

These organic solvents need not be 100 percent pure and may contain impurities such as isomers, unreacted materials, by-products, decomposition products, oxides and moisture in addition to the main components. The content of these impurities is preferably equal to or less than 30 mass percent, more preferably equal to or less than 10 mass percent. Preferably the same type of organic solvent is employed in the magnetic layer and in the nonmagnetic layer. However, the amount added may be varied. The stability of coating is increased by using a solvent with a high surface tension (such as cyclohexanone or dioxane) in the nonmagnetic layer. Specifically, it is preferable that the arithmetic mean value of the upper layer solvent composition be not less than the arithmetic mean value of the nonmagnetic layer solvent composition. To improve dispersion properties, a solvent having a somewhat strong polarity is desirable. It is desirable that solvents having a dielectric constant equal to or higher than 15 are comprised equal to or higher than 50 mass percent of the solvent composition. Further, the dissolution parameter is desirably 8 to 11.

The types and quantities of dispersing agents, lubricants, and surfactants employed in the magnetic layer may differ from those employed in the nonmagnetic layer, described further below, in the present invention. For example (the present invention not being limited to the embodiments given herein), a dispersing agent usually has the property of adsorbing or bonding by means of a polar group. In the magnetic layer, the dispersing agent adsorbs or bonds by means of the polar group primarily to the surface of the ferromagnetic metal powder, and in the nonmagnetic layer, primarily to the surface of the nonmagnetic powder. It is surmised that once an organic phosphorus compound has adsorbed or bonded, it tends not to dislodge readily from the surface of a metal, metal compound, or the like. Accordingly, the surface of a ferromagnetic metal powder or the surface of a nonmagnetic powder becomes covered with the alkyl group, aromatic groups, and the like of the dispersing agent. This enhances the compatibility of the ferromagnetic metal powder or nonmagnetic powder with the binder resin component, further improving the dispersion stability of the ferromagnetic metal powder or nonmagnetic powder. Further, lubricants are normally present in a free state. Thus, it is conceivable to use fatty acids with different melting points in the nonmagnetic layer and magnetic layer to control seepage onto the surface, employ esters with different boiling points and polarity to control seepage onto the surface, regulate the quantity of the surfactant to enhance coating stability, and employ a large quantity of lubricant in the nonmagnetic layer to enhance the lubricating effect. All or some part of the additives employed in the present invention can be added in any of the steps during the manufacturing of coating liquids for the magnetic layer and nonmagnetic layer. For example, there are cases where they are mixed with the ferromagnetic powder prior to the kneading step; cases where they are added during the step in which the ferromagnetic powder, binder, and solvent are kneaded; cases where they are added during the dispersion step; cases where they are added after dispersion; and cases where they are added directly before coating.

Nonmagnetic Layer

Details of the nonmagnetic layer will be described below. The magnetic recording medium of the present invention may comprise a nonmagnetic layer comprising a nonmagnetic powder and a binder between the nonmagnetic support and the magnetic layer. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from 4 μm to 500 nm, more preferably from 40 to 100 μm. A crystallite size falling within a range of 4 nm to 500 nm is desirable in that it facilitates dispersion and imparts a suitable surface roughness. The average particle diameter of the nonmagnetic powder preferably ranges from 5 nm to 500 μm. As needed, nonmagnetic powders of differing average particle diameter may be combined; the same effect may be achieved by broadening the average particle distribution of a single nonmagnetic powder. The particularly preferred average particle diameter of the nonmagnetic powder ranges from 10 to 200 μm. Within a range of 5 nm to 500 nm, dispersion is good and a nonmagnetic layer with good surface roughness can be achieved; the above range is preferred.

The specific surface area of the nonmagnetic powder preferably ranges from 1 to 150 m²/g, more preferably from 20 to 120 m²/g, and further preferably from 50 to 100 m²/g. Within the specific surface area ranging from 1 to 150 m²/g, a nonmagnetic layer with suitable surface roughness can be achieved and dispersion of the nonmagnetic powder is possible with the desired quantity of binder; the above range is preferred. Oil absorption capacity using dibutyl phthalate (DBP) of the nonmagnetic powder preferably ranges from 5 to 100 mL/100 g, more preferably from 10 to 80 mL/100 g, and further preferably from 20 to 60 mL/100 g. The specific gravity ranges from, for example, 1 to 12, preferably from 3 to 6. The tap density ranges from, for example, 0.05 to 2 g/mL, preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder preferably ranges from 2 to 11, more preferably from 6 to 9. When the pH falls within a range of 2 to 11, the coefficient of friction does not become high at high temperature or high humidity or due to the freeing of fatty acids. The moisture content of the nonmagnetic powder preferably ranges from 0.1 to 5 mass percent, more preferably from 0.2 to 3 mass percent, and further preferably from 0.3 to 1.5 mass percent. A moisture content falling within a range of 0.1 to 5 mass percent is desirable because it can produce good dispersion and yield a stable coating viscosity following dispersion. An ignition loss of equal to or less than 20 mass percent is desirable and nonmagnetic powders with low ignition losses are desirable.

When the nonmagnetic powder is an inorganic powder, the Mohs' hardness is preferably 4 to 10. Durability can be ensured if the Mohs' hardness ranges from 4 to 10. The stearic acid (SA) adsorption capacity of the nonmagnetic powder preferably ranges from 1 to 20 μmol/m², more preferably from 2 to 15 μmol/m². The heat of wetting in 25° C. water of the nonmagnetic powder is preferably within a range of 200 to 600 erg/cm² (200 to 600 mJ/m²). A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders preferably contains Al₂O₃, SiO₂, TiO₂, ZrO₂, SnO₂, Sb₂O₃, and ZnO by conducting surface treatment. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the method which comprises a first alumina coating and a second silica coating thereover or the reverse method thereof may also be adopted. Depending on the objective, the surface-treatment coating layer may be a porous layer, with homogeneity and density being generally desirable.

Specific examples of nonmagnetic powders suitable for use in the nonmagnetic layer are: Nanotite from Showa Denko K. K.; HIT-100 and ZA-GL from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-55S, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-100S, MT-100T, MT-150W, MT-500B, T-600B, T-100F and T-500HD from Tayca Corporation; FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Carbon black may be combined with nonmagnetic powder in the nonmagnetic layer to reduce surface resistivity, reduce light transmittance, and achieve a desired micro-Vickers hardness. The micro-Vickers hardness of the nonmagnetic layer is normally 25 to 60 kg/mm² (245 to 588 MPa), desirably 30 to 50 kg/mm² (294 to 490 MPa) to adjust head contact. It can be measured with a thin film hardness meter (HMA-400 made by NEC Corporation) using a diamond triangular needle with a tip radius of 0.1 micrometer and an edge angle of 80 degrees as indenter tip. “Techniques for evaluating thin-film mechanical characteristics,” Realize Corp. can be referred to for details. The light transmittance is generally standardized to an infrared absorbance at a wavelength of about 900 nm equal to or less than 3 percent. For example, in VHS magnetic tapes, it has been standardized to equal to or less than 0.8 percent. To this end, furnace black for rubber, thermal black for rubber, black for coloring, acetylene black and the like may be employed.

The specific surface area of the carbon black employed in the nonmagnetic layer is, for example, 100 to 500 m²/g, preferably 150 to 400 m²/g. The DBP oil absorption capability is, for example, 20 to 400 mL/100 g, preferably 30 to 200 mL/100 g. The particle diameter of the carbon black is, for example, 5 to 80 nm, preferably 10 to 50 mu, and more preferably, 10 to 40 nm. It is preferable that the pH of the carbon black is 2 to 10, the moisture content is 0.1 to 10 percent, and the tap density is 0.1 to 1 g/mL.

Specific examples of types of carbon black employed in the nonmagnetic layer are: BLACK PEARLS 2000, 1300, 1000, 900, 800, 880, 700 and VULCAN XC-72 from Cabot Corporation; #3050B, #3150B, #3250B, #3750B, #3950B, #950, #650B, #970B, #850B and MA-600 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Ketjen Black International Co., Ltd.

The carbon black employed may be surface-treated with a dispersant or grafted with resin, or have a partially graphite-treated surface. The carbon black may be dispersed in advance into the binder prior to addition to the coating liquid. The quantity of the carbon black is preferably within a range not exceeding 50 mass percent of the inorganic powder as well as not exceeding 40 percent of the total mass of the nonmagnetic layer. These carbon blacks may be used singly or in combination. For example, the Carbon Black Handbook compiled by the Carbon Black Association may be consulted for types of carbon black suitable for use in the nonmagnetic layer.

Based on the objective, an organic powder may be added to the nonmagnetic layer. Examples of such an organic powder are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827 may be employed. The contents of the above publications are expressly incorporated herein by reference in their entirety.

Binder resins, lubricants, dispersing agents, additives, solvents, dispersion methods, and the like suited to the magnetic layer may be adopted to the nonmagnetic layer. In particular, known techniques for the quantity and type of binder resin and the quantity and type of additives and dispersion agents employed in the magnetic layer may be adopted thereto.

An undercoating layer can be provided in the magnetic recording medium of the present invention. Providing an undercoating layer can enhance adhesive strength between the support and the magnetic layer or nonmagnetic layer. For example, a polyester resin that is soluble in solvent can be employed as the undercoating layer.

Layer Structure

As for the thickness structure of the magnetic recording medium of the present invention, the thickness of the nonmagnetic support preferably ranges from 3 to 80 micrometers, more preferably from 3 to 50 micrometers, further preferably from 3 to 10 micrometers, as set forth above. When an undercoating layer is provided between the nonmagnetic support and the nonmagnetic layer or the magnetic layer, the thickness of the undercoating layer ranges from, for example, 0.01 to 0.8 micrometer, preferably 0.02 to 0.6 micrometer.

The thickness of the magnetic layer is as set forth above. The thickness variation in the magnetic layer is preferably within ±50 percent, more preferably within ±30 percent. At least one magnetic layer is sufficient. The magnetic layer may be divided into two or more layers having different magnetic characteristics, and a known configuration relating to multilayered magnetic layer may be applied.

The thickness of the nonmagnetic layer ranges from, for example, 0.1 to 3.0 μm, preferably 0.3 to 2.0 μm, and more preferably 0.5 to 1.5 μm. The nonmagnetic layer is effective so long as it is substantially nonmagnetic. For example, it exhibits the effect of the present invention even when it comprises impurities or trace amounts of magnetic material that have been intentionally incorporated, and can be viewed as substantially having the same configuration as the magnetic recording medium of the present invention. The term “substantially nonmagnetic” is used to mean having a residual magnetic flux density in the nonmagnetic layer of equal to or less than 10 mT, or a coercivity of equal to or less than 7.96 kA/m (100 Oe), it being preferable not to have a residual magnetic flux density or coercivity at all.

Back Layer

A back layer is desirably provided on the opposite surface of the nonmagnetic support, in the magnetic recording medium of the present invention. The back layer desirably comprises carbon black and inorganic powder. The formula of the magnetic layer or nonmagnetic layer can be applied to the binder and various additives. The back layer is preferably equal to or less than 0.9 micrometer, more preferably 0.1 to 0.7 micrometer, in thickness.

Manufacturing Method

The manufacturing method of the magnetic recording medium of the present invention comprises, for example, the steps of coating a magnetic layer coating liquid containing ferromagnetic powder and binder on at least one surface of a nonmagnetic support to obtain a coated stock material; winding the coated stock material on a take-up roll; unwinding the coated stock material that has been wound on the take-up roll and subjecting it to calendering.

The process for manufacturing magnetic layer and nonmagnetic layer coating liquids normally comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these publications are incorporated herein by reference in their entirety. Further, glass beads may be employed to disperse the magnetic layer and nonmagnetic layer coating liquids, with a dispersing medium with a high specific gravity such as zirconia beads, titania beads, and steel beads being suitable for use as the glass beads. The particle diameter and fill ratio of these dispersing media can be optimized for use. A known dispersing device may be employed.

In manufacturing the magnetic layer coating liquid, dispersion is preferably enhanced by controlling dispersion conditions (such as types and quantities of beads employed in dispersion, peripheral speed, and dispersion period). As stated above, to effectively inhibit reaggregation during drying, it is desirable to grade the magnetic layer coating liquid prior to coating to break up coarse particles serving as reaggregation nuclei during drying. Any of the following methods may be employed as the grading process in the present invention: natural sedimentation controlling the particle size distribution based on liquid concentration and time, and centrifugal sedimentation controlling the particle size distribution based on liquid concentration, the rotational speed of the centrifugal separator, or the processing time.

In the method of manufacturing the magnetic recording medium, for example, the magnetic layer can be formed by coating a magnetic layer coating liquid to a prescribed film thickness on the surface of a nonmagnetic support while the nonmagnetic support is running. Multiple magnetic layer coating liquids can be successively or simultaneously coated in a multilayer coating, and the nonmagnetic layer coating liquid and the magnetic layer coating liquid can be successively or simultaneously applied in a multilayer coating. To achieve a desired Sdc/Sac as set forth above, the nonmagnetic layer coating liquid and magnetic layer coating liquid are desirably successively coated in a multilayer coating (wet-on-dry).

Coating machines suitable for use in coating the magnetic layer and nonmagnetic layer coating liquids are air doctor coaters, blade coaters, rod coaters, extrusion coaters, air knife coaters, squeeze coaters, immersion coaters, reverse roll coaters, transfer roll coaters, gravure coaters, kiss coaters, cast coaters, spray coaters, spin coaters, and the like. For example, “Recent Coating Techniques” (May 31, 1983), issued by the Sogo Gijutsu Center K.K. may be referred to in this regard.

The magnetic recording medium of the present invention can be a magnetic tape such as a video tape or computer tape, or a magnetic disk such as a flexible disk or hard disk. When it is a magnetic tape, the coating layer that is formed by applying the magnetic layer coating liquid can be magnetic field orientation processed using cobalt magnets or solenoids on the ferromagnetic powder contained in the coating layer. When it is a disk, an adequately isotropic orientation can be achieved in some products without orientation using an orientation device, but the use of a known random orientation device in which cobalt magnets are alternately arranged diagonally, or alternating fields are applied by solenoids, is desirable. In the case of ferromagnetic metal powder, the term “isotropic orientation” generally refers to a two-dimensional in-plane random orientation, which is desirable, but can refer to a three-dimensional random orientation achieved by imparting a perpendicular component. Further, a known method, such as opposing magnets of opposite poles, can be employed to effect perpendicular orientation, thereby imparting an isotropic magnetic characteristic in the peripheral direction. Perpendicular orientation is particularly desirable when conducting high-density recording. Spin coating can be used to effect peripheral orientation. As set forth above, an intense shear can be imparted after coating and orientation to effectively break up magnetic clusters that have aggregated due to orientation, as described in Japanese Unexamined Patent Publication (KOKAI) No. 2004-103186.

The drying position of the coating is desirably controlled by controlling the temperature and flow rate of drying air, and coating speed. A coating speed of 20 m/min to 1,000 m/min and a dry air temperature of equal to or higher than 60° C. are desirable. Suitable predrying can be conducted prior to entry into the magnet zone.

The coated stock material thus obtained can be normally temporarily wound on a take-up roll, and then unwound from the take-up roll and calendered.

For example, super calender rolls can be employed in calendering. Calendering can enhance surface smoothness, eliminate voids produced by the removal of solvent during drying, and increase the fill rate of the ferromagnetic powder in the magnetic layer, thus yielding a magnetic recording medium of good electromagnetic characteristics. The calendering step is desirably conducted by varying the calendering conditions based on the smoothness of the surface of the coated stock material.

The glossiness of the coated stock material may decrease roughly from the center of the take-up roll toward the outside, and there is sometimes variation in the quality in the longitudinal direction. Glossiness is known to correlate (proportionally) to the surface roughness Ra. Accordingly, when the calendering conditions are not varied in the calendering step, such as by maintaining a constant calender roll pressure, there is no countermeasure for the difference in smoothness in the longitudinal direction resulting from winding of the coated stock material, and the variation in quality in the longitudinal direction tends to carry over into the final product.

Accordingly, in the calendering step, it is desirable to vary the calendering conditions, such as the calender roll pressure, to cancel out the different in smoothness in the longitudinal direction that is produced by winding of the coated stock material. Specifically, it is desirable to reduce the calender roll pressure from the center to the outside of the coated stock material that is wound off the take-up roll. Based on an investigation by the present inventors, lowering the calender roll pressure decreases the glossiness (smoothness diminishes). Thus, the difference in smoothness in the longitudinal direction that is produced by winding of the coated stock material is cancelled out, yielding a final product free of variation in quality in the longitudinal direction.

An example of changing the pressure of the calender rolls has been described above to control the surface smoothness. Additionally, it is possible to control the surface smoothness by means of the calender roll temperature, calender roll speed, and calender roll tension. Taking into account the properties of a particulate medium, it is desirable to control the surface smoothness by means of the calender roll pressure and calender roll temperature. Generally, the calender roll pressure is reduced, or the calender roll temperature is lowered, to diminish the surface smoothness of the final product. Conversely, the calender roll pressure can be increased or the calender roll temperature can be raised to increase the surface smoothness of the final product.

Alternatively, the magnetic recording medium obtained following the calendering step can be thermally processed to promote thermal curing. Such thermal processing can be suitably determined based on the blending formula of the magnetic layer coating liquid. The thermal processing temperature is, for example, 35 to 100° C., desirably 50 to 80° C. The thermal processing time is 12 to 72 hours, desirably 24 to 48 hours.

Rolls of a heat-resistant plastic such as epoxy, polyimide, polyamide, or polyamidoimide, can be employed as the calender rolls. Processing with metal rolls is also possible.

It is desirable for the magnetic recording medium of the present invention to have extremely good smoothness in the form of a center surface average roughness of the magnetic layer surface (at a cutoff value of 0.25 mm) of 0.1 to 4 nm, preferably within a range of 1 to 3 nm. The calendering conditions required to achieve this are as follows. The calender roll temperature desirably ranges from 60 to 100° C., preferably ranges from 70 to 100° C., and more preferably ranges from 80 to 100° C. The pressure desirably ranges from 100 to 500 kg/cm (98 to 490 kN/m), preferably ranges from 200 to 450 kg/cm (196 to 441 kN/m), and more preferably, ranges from 300 to 400 kg/cm (294 to 392 kN/m).

The magnetic recording medium obtained can be cut to desired size with a cutter or the like for use. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like are suitably selected.

Physical Properties

The saturation magnetic flux density of the magnet layer in the magnetic recording medium of the present invention is preferably 100 to 400 mT. The coercivity (Hc) of the magnetic layer is preferably 143.2 to 318.3 kA/m (1,800 to 4,000 Oe), more preferably 159.2 to 278.5 kA/m (2,000 to 3,5000e). Narrower coercivity distribution is preferable. The SFD and SFDr are preferably equal to or lower than 0.6, more preferably equal to or lower than 0.3.

The coefficient of friction of the magnetic recording medium of the present invention relative to the head is desirably equal to or less than 0.50 and preferably equal to or less than 0.3 at temperatures ranging from −10° C. to 40° C. and humidity ranging from 0 percent to 95 percent, the surface resistivity on the magnetic surface preferably ranges from 104 to 108 ohm/sq, and the charge potential preferably ranges from −500 V to +500 V. The modulus of elasticity at 0.5 percent extension of the magnetic layer preferably ranges from 0.98 to 19.6 GPa (100 to 2,000 kg/mm²) in each in-plane direction. The breaking strength preferably ranges from 98 to 686 MPa (10 to 70 kg/mm²). The modulus of elasticity of the magnetic recording medium preferably ranges from 0.98 to 14.7 GPa (100 to 1500 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature (the peak loss tangent based on measurement of dynamic viscoelasticity at 110 Hz) of the magnetic layer preferably ranges from 50 to 180° C., and that of the nonmagnetic layer preferably ranges from 0 to 180° C. The loss elastic modulus preferably falls within a range of 1×10⁷ to 8×10⁸ Pa (1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by equal to or less than 10 percent, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 30 volume percent, more preferably equal to or less than 20 volume percent. Although a low void ratio is preferable for attaining high output, there are some cases in which it is better to ensure a certain level based on the object. For example, in many cases, larger void ratio permits preferred running durability in disk media in which repeat use is important.

When the magnetic recording medium of the present invention comprises a nonmagnetic layer and a magnetic layer, physical properties of the nonmagnetic layer and magnetic layer may be varied based on the objective. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

The magnetic recording medium of the present invention is suited to magnetic recording and reproduction systems employing MR heads with higher sensitivity than conventional MR heads, specifically, highly sensitive AMR heads or giant magnetoresistive (GMR) heads, as reproduction heads. It is particularly suited to magnetic recording and reproduction systems employing GMR heads as reproduction heads. GMR heads employ a magnetoresistive effect corresponding to the size of the magnetic flux exerted on thin-film magnetic heads, affording the advantage of yielding a reproduction output higher than what can be achieved with inductive heads. This is primarily because, since the reproduction output of GMR heads is based on the change in magnetic resistance, it is not dependent on the relative speed of the head and the disk, making it possible to achieve a higher output than inductive magnetic heads. Reading sensitivity is about three times higher than that of conventional AMR heads. The use of such a GMR head as the reproduction head permits excellent reproduction characteristics in the high frequency region.

When the magnetic recording medium of the present invention is in the form of a tape-shaped magnetic recording medium, the use of a GMR head as reproduction head permits reproduction at a high S/N ratio even when the signal has been recorded in a higher frequency region than is conventionally the case. Accordingly, the magnetic recording medium of the present invention is optimal as a magnetic recording medium in either magnetic tape or disk form for use in high-density recording of computer data.

[Magnetic Signal Reproduction System, Magnetic Signal Reproduction Method]

The present invention further relates to a magnetic signal reproduction system comprising the magnetic recording medium of the present invention and a reproduction head, and to a magnetic signal reproduction method reproducing magnetic signals that have been recorded on the magnetic recording medium of the present invention with a reproduction head.

The magnetic recording medium of the present invention can achieve a high S/N ratio during high-density recording by inhibiting the output drop and noise increase caused by the medium. Normally, two units denoting linear recording density are employed: fci and bpi. “fci” denotes the density that is physically recorded on the medium as the number of bit reversals per inch, while “bpi” denotes the number of bits per inch, including signal processing, and is system-dependent. Thus, the fci is normally employed for pure performance evaluation of a medium. The desirable linear recording density range in the course of recording a signal on the magnetic recording medium of the present invention is 100 to 400 kfci, with 175 to 400 kfci being preferred. In systems actually in use, this depends on signal processing, and cannot be determined once and for all. As a general guideline, performance is reflected by an fci of 0.5 to one times the bpi. Thus, a range of 200 to 800 kbpi is desirable, 350 to 800 kbpi being particularly preferred.

The above reproduction head is desirably a GMR head. With GMR heads, highly sensitive reproduction is possible even at a reproduction track width is set to equal to or less than 3 micrometers (desirably 0.1 to 3 micrometers), for example, to reproduce signals that have been recorded at high density. Further, with the magnetic recording medium of the present invention, it is possible to achieve a good S/N ratio during reproduction with GMR heads. That is, in the magnetic signal reproduction system and magnetic recording and reproduction method of the present invention, the use of the magnetic recording medium of the present invention with a GMR head permits the reproduction with a good S/N ratio of signals recorded at high density.

A highly sensitive AMR head can be also employed as the above reproduction head. Generally, the coefficient of magnetoresistance is employed as the indicator of sensitivity of a head. Commonly employed magnetoresistive elements have a coefficient of magnetoresistance of about 2 percent at a thickness of 200 to 300 nm. By contrast, it is about 2 to 5 percent for highly sensitive AMR heads. When employing a highly sensitive AMR head, it is also possible to reproduce with high sensitivity signals that have been recorded on the magnetic recording medium of the present invention to achieve a high S/N ratio.

### EXAMPLES

The present invention will be described in detail below based on Examples. However, the present invention is not limited to the embodiments described in Examples. The term “parts” given in Examples are mass parts.

### Examples 1-1 to 1-13

Preparation of magnetic layer coating liquid 1
(ferromagnetic powder: hexagonal ferrite powder)

| | | |
|---|---|---|
| Ferromagnetic plate-shaped hexagonal ferrite powder | 100 | parts |
| Composition other than oxygen (molar ratio): | | |
| Ba/Fe/Co/Zn = 1/9/0.2/1 | | |
| Hc: 15.9 kA/m (2200 Oe) | | |
| Plate diameter and plate ratio: see Table 1 | | |
| BET specific surface area: 65 m²/g | | |
| σs: 49 A · m²/kg (49 emu/g) | | |
| Polyurethane resin based on branched side chain- | 15 | parts |
| comprising polyester polyol/diphenylmethane | | |
| diisocyanate, —SO₃Na = 400 eq/ton | | |
| α-Al₂O₃ (particle size: 0.15 micrometer) | 4 | parts |
| Plate-shaped alumina powder (average particle | 0.5 | part |
| diameter: 50 nm) | | |
| Diamond powder (average particle diameter: 60 nm) | 0.5 | part |
| Carbon black (particle size: 20 nm) | 1 | part |
| Cyclohexanone | 110 | parts |
| Methyl ethyl ketone | 100 | parts |
| Toluene | 100 | parts |
| Butyl stearate | 2 | parts |
| Stearic acid | 1 | part |

Preparation of nonmagnetic layer coating liquid

| | | |
|---|---|---|
| Nonmagnetic inorganic powder | 85 | parts |
| α-iron oxide | | |
| Surface treatment agent: Al₂O₃, SiO₂ | | |
| Major axis diameter: 0.15 micrometer | | |
| Tap density: 0.8 | | |
| Acicular ratio: 7 | | |
| BET specific surface area: 52 m²/g | | |
| pH: 8 | | |
| DBP oil absorption capacity: 33 g/100 g | | |
| Carbon black | 15 | parts |
| DBP oil absorption capacity: 120 mL/100 g | | |
| pH: 8 | | |
| BET specific surface area: 250 m²/g | | |
| Volatile content: 1.5 percent | | |
| Polyurethane resin based on branched side chain- | 22 | parts |
| comprising polyester polyol/diphenylmethane | | |
| diisocyanate, —SO₃Na = 200 eq/ton | | |
| Phenylphosphonic acid | 3 | parts |
| Cyclohexanone | 140 | parts |
| Methyl ethyl ketone | 170 | parts |
| Butyl stearate | 2 | part |
| Stearic acid | 1 | part |

Preparation of backcoat layer coating liquid

| | | |
|---|---|---|
| Carbon black (average particle diameter: 25 nm) | 40.5 | parts |
| Carbon black (average particle diameter: 370 nm) | 0.5 | part |
| Barium sulfate | 4.05 | parts |
| Nitrocellulose | 28 | parts |
| SO₃Na group-containing polyurethane resin | 20 | parts |
| Cyclohexanone | 100 | parts |
| Toluene | 100 | parts |
| Methyl ethyl ketone | 100 | parts |

The components of each of the above-described magnetic layer coating liquid, nonmagnetic layer coating liquid, and backcoat layer coating liquid were kneaded for 240 minutes in an open kneader and dispersed using a bead mill (1,440 minutes for the magnetic layer coating liquid, 720 minutes for the nonmagnetic layer coating liquid, and 720 hours for the backcoat layer coating liquid). To each of the dispersions obtained were added four parts of trifunctional low-molecular-weight polyisocyanate compound (Coronate 3041 made by Nippon Polyurethane Industry Co.), and the mixtures were stirred for another 20 minutes. Subsequently, the mixtures were filtered using a filter having an average pore diameter of 0.5 micrometer. The magnetic layer coating liquid was then centrifugally separated for the period indicated in Table 1 at a rotational speed of 10,000 rpnm in a cooled centrifugal separator, the Himac CR-21D, made by Hitachi High Tech, to conduct grading to remove the aggregate.

The nonmagnetic layer coating liquid obtained was coated to a PEN support with a thickness of 5 micrometer (an average surface roughness Ra=1.5 nm as measured with an HD2000 made by WYKO) in a quantity calculated to yield a dry thickness of 1.5 micrometer, and dried at 100° C. The support stock material on which the nonmagnetic layer had been coated was then subjected to a 24-hour heat treatment at 70° C. The magnetic layer coating liquid that had been graded was wet-on-dry coated on the nonmagnetic layer in a quantity calculated to yield the thickness given in Table 1 upon drying and dried at 100° C. A seven-stage calender comprised only of metal rolls was then used to conduct processing to smoothen the surface at a temperature of 100° C. and a linear pressure of 350 kg/cm at a speed of 100 m/min. The material was then slit into a ½ inch width to obtain magnetic tape.

### Comparative Example 1-1

With the exception that the thickness of the magnetic layer was changed to 100 rm, magnetic tape was prepared by the same method as in Example 1-1.

### Comparative Example 1-2

With the exception that the thickness of the magnetic layer was changed to 50 nm, magnetic tape was prepared by the same method as in Example 5 of Japanese Unexamined Patent Publication (KOKAI) No. 2004-103186.

### Comparative Example 1-3

With the exceptions that the thickness of the magnetic layer was changed to 10 nm and the quantity of polyurethane in the magnetic layer coating liquid was changed to 30 parts, magnetic tape was prepared by the same method as in Example 1-1.

### Comparative Example 1-4

With the exception that the thickness of the magnetic layer was changed to 10 nm, magnetic tape was prepared by the same method as in Example 1-1.

### Comparative Example 1-5

With the exception that the thickness of the magnetic layer was changed to 80 nn, magnetic tape was prepared by the same method as in Example 1-1.

### Comparative Example 1-6

Magnetic tape was prepared by the same method as that described in Example 5 of Japanese Unexamined Patent Publication (KOKAI) No. 2004-103186.

### Comparative Example 1-7

With the exception that the thickness of the magnetic layer was changed to 45 nm, magnetic tape was prepared by the same method as that described in Example 5 of Japanese Unexamined Patent Publication (KOKAI) No. 2004-103186.

### Example 2-1

With the exception that the magnetic layer coating liquid was changed to magnetic layer coating liquid 2 below, magnetic tape was prepared by the same method as in Example 1-1.

Magnetic layer coating liquid 2 (ferromagnetic
powder: iron nitride powder)

| | | |
|---|---|---|
| Iron nitride magnetic powder (average particle | 100 | parts |
| diameter: see Table 2) | | |
| Hc: 15.9 kA/m (2000 Oe) | | |
| BET specific surface area: 63 m²/g | | |
| σs: 100 A · m²/kg (100 emu/g) | | |
| Vinyl chloride-hydroxypropyl acrylate copolymer | 8 | parts |
| resin (—SO₃Na group content: 0.7 × 10⁻⁴ | | |
| eq/g) | | |
| Polyurethane resin based on branched side chain- | 25 | parts |
| comprising polyester polyol/diphenylmethane | | |
| diisocyanate, —SO₃Na = 400 eq/ton | | |
| α-alumina (average particle diameter: 80 nm) | 5 | parts |
| Plate-shaped alumina powder (average particle | 1 | part |
| diameter: 50 nm) | | |
| Diamond powder (average particle diameter: 80 nm) | 1 | part |
| Carbon black (average particle diameter: 25 nm) | 1.5 | parts |
| Myristic acid | 1.5 | parts |
| Methyl ethyl ketone | 133 | parts |
| Toluene | 100 | parts |
| Stearic acid | 1.5 | parts |
| Polyisocyanate (Coronate L made by Nippon Polyurethane | 4 | parts |
| Industry Co. Ltd.) | | |
| Cyclohexanone | 133 | parts |
| Toluene | 33 | parts |

### Examples 2-2 to 2-9

Magnetic tapes were prepared by the same method as in Example 2-1 employing the centrifugal separation time for the magnetic layer coating liquid, average particle diameter for the iron nitride powder employed, and magnetic layer thickness indicated in Table 2.

### Comparative Example 2-1

With the exception that a magnetic layer thickness of 100 nm was employed, magnetic tape was prepared by the same method as in Example 2-1.

### Comparative Example 2-2

With the exception that the magnetic layer coating liquid was not centrifugally separated, magnetic tape was prepared by the same method as in Example 2-2.

### Comparative Example 2-3

With the exception that the magnetic layer thickness was changed to 10 nm, magnetic tape was prepared by the same method as in Example 2-1.

### Comparative Example 2-4

With the exception that the centrifugal separation time indicated in Table 2 was employed for the magnetic layer coating liquid, magnetic tape was prepared by the same method as in Example 2-3.

### Comparative Example 2-5

With the exception that the centrifugal separation time indicated in Table 2 was employed for the magnetic layer coating liquid, magnetic tape was prepared by the same method as in Example 2-1.

[Evaluation Methods]

### 1. Average Particle Size (Plate Diameter and Plate Ratio of Hexagonal Ferrite Powder, Average Particle Diameter of Iron Nitride Powder)

Diluted magnetic particles were placed and dried on a Cu 200 mesh on which a carbon film has been adhered, a negative was shot at 100.000-fold magnification by TEM (1200EX made by JEOL), the negative was measured with a particle diameter measuring device (KS-400 made by Carl Zeiss), and the average particle size was calculated from the arithmetic average particle diameter measured.

### 2. D95

A 0.5 mg quantity of liquid following grading of the magnetic layer coating liquid was diluted with 49.5 mg of methyl ethyl ketone and the particle size distribution was measured in the liquid with a model LB-500 laser-scattering particle size analyzer made by Horiba. The particle diameter that yielded a cumulative volume of 95 percent at the distribution ratio of the particles of the various diameters present was calculated.

### 3. Mrδ

Measured at Hm 796 kA/m (10 kOe) with a vibrating sample fluxmeter (made by Toei Industry Co.).

### 4. Magnetic Clusters

A sample that had been demagnetized in an alternating current magnetic field and a sample that had been direct-current demagnetized with an external magnetic field of 796 kA/m (10 kOe) using a vibrating sample fluxmeter (made by Toei Industry Co.) were measured at a lift height of 40 nm over a range of 5×5 micrometers with a Nanoscope III made by Digital Instruments in MFM mode to obtain magnetic force images. The threshold was set to 70 percent of the standard deviation (rms) value of the magnetic force distribution, the images were converted to binary, and only portions having a magnetic force of equal to or greater than 70 percent were displayed. The image was inputted to an image analyzer (K2-400 made by Carl Zeiss). After removing the noise and filling holes, the average area was calculated. Ten spots were measured and the average value was calculated.

### 5. Electromagnetic Characteristics (S/N Ratio)

Electromagnetic characteristics were measured with a drum tester (relative speed 5 m/s). A write head with a gap length of 0.2 micrometer and Bs=1.6 T was used to record a signal at a linear recording density of X kfci. The signal was reproduced with a GMR head (Tw width 3 micrometers, sh-sh=0.18 micrometer). The ratio of the X kfci output to 0 to 2×X kfci integral noise was measured (for values of X of 100, 200, 300, and 400).

### Example 1-14

The electromagnetic characteristic evaluation of 5. above was conducted with an AMR head (Tw width 2 micrometers, Sh-Sh=0.2 micrometer, magnetoresistance coefficient 4 percent) for the magnetic tape of Example 1-2.

### Comparative Example 1-8

The electromagnetic characteristic evaluation of 5. above was conducted with an AMR head (Tw width 2 micrometers, Sh-Sh=0.2 micrometer, magnetoresistance coefficient 4 percent) for the magnetic tape of Comparative Example 1-1.

[Table 1]

TABLE 1

| | Hexagonal ferrite powder | | Centrifugal | | | Magnetic layer | | | | |
|---|---|---|---|---|---|---|---|---|---|---|
| | Average plate | Average | separation time | | D95 | thickness | Mr δ | Sdc | Sac | |
| | diameter(nm) | plate ratio | (min) | Smoothing | (nm) | (μm) | (mA) | (nm2) | (nm2) | Sdc/Sac |
| Example 1- 1 | 25 | 3 | 30 | None | 65 | 20 | 1.2 | 14000 | 15000 | 0.93 |
| Example 1- 2 | 25 | 3 | 30 | None | 65 | 50 | 3 | 16000 | 15000 | 1.07 |
| Example 1- 3 | 25 | 3 | 30 | None | 65 | 80 | 4.8 | 16500 | 15000 | 1.10 |
| Example 1- 4 | 25 | 3 | 20 | None | 70 | 50 | 3 | 28500 | 15000 | 1.90 |
| Example 1- 5 | 10 | 3 | 60 | None | 55 | 50 | 3 | 11000 | 8000 | 1.38 |
| Example 1- 6 | 15 | 3 | 45 | None | 60 | 50 | 3 | 14000 | 11000 | 1.27 |
| Example 1- 7 | 40 | 3 | 15 | None | 70 | 50 | 3 | 21000 | 20000 | 1.05 |
| Example 1- 8 | 5 | 3 | 120 | None | 60 | 50 | 3 | 7000 | 6000 | 1.17 |
| Example 1- 9 | 45 | 3 | 10 | None | 70 | 50 | 3 | 30000 | 24000 | 1.25 |
| Example 1- 10 | 25 | 1.5 | 15 | None | 60 | 50 | 3 | 13000 | 12000 | 1.08 |
| Example 1- 11 | 25 | 4.5 | 90 | None | 65 | 50 | 3 | 21000 | 17000 | 1.24 |
| Example 1- 12 | 25 | 1 | 10 | None | 60 | 50 | 3 | 9000 | 10000 | 0.90 |
| Example 1- 13 | 25 | 5 | 120 | None | 65 | 50 | 3 | 26000 | 19000 | 1.37 |
| Example 1- 14 | 25 | 3 | 30 | None | 65 | 50 | 3 | 16000 | 15000 | 1.07 |
| Comp. Ex. 1- 1 | 25 | 3 | 30 | None | 65 | 100 | 6 | 17000 | 16000 | 1.06 |
| Comp. Ex. 1- 2 | 25 | 3 | 0 | Conducted | 80 | 50 | 3 | 34000 | 15000 | 2.27 |
| Comp. Ex. 1- 3 | 25 | 3 | 30 | None | 65 | 20 | 0.6 | 14000 | 15000 | 0.93 |
| Comp. Ex. 1- 4 | 25 | 3 | 30 | None | 65 | 10 | 0.6 | 14000 | 14000 | 1.00 |
| Comp. Ex. 1- 5 | 25 | 3 | 30 | None | 65 | 80 | 8 | 17000 | 15000 | 1.13 |
| Comp. Ex. 1- 6 | 25 | 3 | 0 | Conducted | 85 | 100 | 10 | 18000 | 15000 | 1.20 |
| Comp. Ex. 1- 7 | 25 | 3 | 0 | Conducted | 85 | 45 | 4.8 | 42000 | 16000 | 2.63 |
| Comp. Ex. 1- 8 | 25 | 3 | 30 | None | 65 | 100 | 6 | 17000 | 16000 | 1.06 |

| | 100 | | | 200 | | | 300 | | | 400 | | |
|---|---|---|---|---|---|---|---|---|---|---|---|---|
| | Signal | Noise | SNR | Signal | Noise | SNR | Signal | Noise | SNR | Signal | Noise | SNR |
| | (dB) | (dB) | (dB) | (dB) | (dB) | (dB) | (dB) | (dB) | (dB) | (dB) | (dB) | (dB) |
| Example 1- 1 | −10 | −8 | −2 | −6 | −7 | 1 | −3 | −8 | 5 | 0 | −9 | 9 |
| Example 1- 2 | −3 | −4 | 1 | −1 | −5 | 4 | 2 | −6 | 8 | 4 | −7 | 11 |
| Example 1- 3 | 0 | −2 | 2 | 1 | −3 | 4 | 2 | −4 | 6 | 3 | −5 | 8 |
| Example 1- 4 | −4 | −2 | −2 | −2 | −3 | 1 | 0 | −4 | 4 | 1 | −4 | 3 |
| Example 1- 5 | −10 | −9 | −1 | −5 | −8 | 3 | −3 | −9 | 6 | 0 | −10 | 11 |
| Example 1- 6 | −5 | −6 | 1 | −3 | −7 | 4 | 1 | −9 | 8 | 4 | −10 | 14 |
| Example 1- 7 | 1 | −1 | 2 | 1 | −2 | 3 | 1 | −3 | 4 | 2 | −4 | 6 |
| Example 1- 8 | −12 | −9 | −3 | −8 | −9 | 1 | −8 | −10 | 2 | −8 | −11 | 3 |
| Example 1- 9 | 5 | 1 | 4 | 3 | 0 | 3 | 1 | −1 | 2 | −1 | −2 | 1 |
| Example 1- 10 | −2 | −5 | 3 | −1 | −5 | 4 | 0 | −6 | 6 | 1 | −7 | 8 |
| Example 1- 11 | −5 | −3 | −2 | −1 | −4 | 3 | 3 | −4 | 7 | 6 | −6 | 12 |
| Example 1- 12 | −2 | −5 | 3 | −2 | −4 | 2 | −2 | −4 | 2 | −3 | −5 | 2 |
| Example 1- 13 | −6 | −2 | −4 | −2 | −3 | 1 | 0 | −2 | 2 | 2 | −4 | 2 |
| Example 1- 14 | −12 | −9 | −3 | −11 | −10 | −1 | −10 | −10 | 0 | −9 | −10 | 1 |
| Comp. Ex. 1- 1 | 0 | 0 | 0 | 0 | 0 | 0 | 0 | 0 | 0 | 0 | 0 | 0 |
| Comp. Ex. 1- 2 | −5 | −3 | −2 | −5 | −1 | −4 | −5 | 0 | −5 | −5 | 1 | −6 |
| Comp. Ex. 1- 3 | −18 | −10 | −8 | −13 | −10 | −3 | −10 | −10 | 0 | −10 | −10 | 0 |
| Comp. Ex. 1- 4 | −18 | −10 | −8 | −13 | −9 | −4 | −11 | −9 | −2 | −11 | −9 | −2 |
| Comp. Ex. 1- 5 | −1 | 2 | −3 | −2 | 3 | −5 | −3 | 4 | −7 | −4 | 4 | −8 |
| Comp. Ex. 1- 6 | −2 | 5 | −3 | −3 | 6 | −7 | −4 | 7 | −11 | −5 | 8 | −13 |
| Comp. Ex. 1- 7 | −5 | −1 | −4 | −5 | 0 | −5 | −7 | 1 | −8 | −7 | 2 | −9 |
| Comp. Ex. 1- 8 | −9 | −6 | −3 | −10 | −6 | −4 | −12 | −6 | −6 | −15 | −6 | −9 |

TABLE 2

| | Average particle | Centrifugal | | Magnetic | | | | |
|---|---|---|---|---|---|---|---|---|
| | diameter of iron | separation | | layer | | | | |
| | nitride | time | D95 | thickness | Mr δ | Sdc | Sac | |
| | (nm) | (min) | (nm) | (μm) | (mA) | (nm²) | (nm^{z}) | Sdc/Sac |
| Example 2- 1 | 15 | 30 | 70 | 20 | 1.2 | 35000 | 24000 | 1.46 |
| Example 2- 2 | 15 | 30 | 70 | 50 | 3 | 38000 | 24000 | 1.58 |
| Example 2- 3 | 15 | 30 | 70 | 80 | 4.8 | 37000 | 23000 | 1.61 |
| Example 2- 4 | 15 | 20 | 83 | 50 | 3 | 44000 | 23000 | 1.91 |
| Example 2- 5 | 12 | 90 | 65 | 50 | 3 | 24000 | 15000 | 1.60 |
| Example 2- 6 | 20 | 20 | 75 | 50 | 3 | 42000 | 32000 | 1.31 |
| Example 2- 7 | 25 | 15 | 70 | 50 | 3 | 56000 | 40000 | 1.40 |
| Example 2- 8 | 10 | 120 | 60 | 50 | 3 | 19000 | 12000 | 1.58 |
| Example 2- 9 | 30 | 10 | 80 | 50 | 3 | 70000 | 50000 | 1.40 |
| Comp. Ex. 2- 1 | 15 | 30 | 70 | 100 | 6 | 36000 | 22000 | 1.64 |
| Comp. Ex. 2- 2 | 15 | 0 | 90 | 50 | 3 | 60000 | 25000 | 2.40 |
| Comp. Ex. 2- 3 | 15 | 30 | 70 | 10 | 0.6 | 34000 | 24000 | 1.42 |
| Comp. Ex. 2- 4 | 15 | 60 | 70 | 80 | 8 | 38000 | 23000 | 1.65 |
| Comp. Ex. 2- 5 | 15 | 60 | 70 | 20 | 0.6 | 32000 | 24000 | 1.33 |

| | 100 | | | 200 | | | 300 | | | 400 | | |
|---|---|---|---|---|---|---|---|---|---|---|---|---|
| | Signal | Noise | SNR | Signal | Noise | SNR | Signal | Noise | SNR | Signal | Noise | SNR |
| | (dB) | (dB) | (dB) | (dB) | (dB) | (dB) | (dB) | (dB) | (dB) | (dB) | (dB) | (dB) |
| Example 2- 1 | −11 | −8 | −3 | −5 | −6 | 1 | −4 | −8 | 4 | −1 | −9 | 8 |
| Example 2- 2 | −4 | −3 | −1 | −1 | −4 | 3 | 2 | −5 | 7 | 4 | −7 | 11 |
| Example 2- 3 | 0 | −3 | 3 | 1 | −3 | 2 | 1 | −4 | 5 | 0 | −4 | 4 |
| Example 2- 4 | −5 | −2 | −3 | −2 | −3 | 1 | 1 | −4 | 5 | 2 | −3 | 5 |
| Example 2- 5 | −11 | −7 | −4 | −4 | −8 | 4 | −3 | −10 | 7 | 0 | −10 | 10 |
| Example 2- 6 | −7 | −5 | −2 | −3 | −8 | 5 | 0 | −9 | 9 | 4 | −7 | 11 |
| Example 2- 7 | 1 | 0 | 1 | 0 | −3 | 3 | 0 | −4 | 4 | 2 | −4 | 6 |
| Example 2- 8 | −13 | −9 | −4 | −7 | −8 | 1 | −7 | −9 | 2 | −6 | −8 | 2 |
| Example 2- 9 | 4 | −1 | 5 | 2 | 0 | 2 | 2 | −2 | 2 | 0 | −2 | 2 |
| Comp. Ex. 2- 1 | 0 | 0 | 0 | 0 | 0 | 0 | 0 | 0 | 0 | 0 | 0 | 0 |
| Comp. Ex. 2- 2 | −6 | −4 | −2 | −4 | −4 | 0 | −2 | −1 | −1 | −1 | 0 | −1 |
| Comp. Ex. 2- 3^{Note)} | — | — | — | — | — | — | — | — | — | — | — | — |
| Comp. Ex. 2- 4 | 0 | 1 | −1 | −2 | −2 | 0 | 1 | 1 | 0 | 2 | 4 | −2 |
| Comp. Ex. 2- 5 | −17 | −11 | −6 | −11 | −9 | −2 | −10 | −9 | −1 | −7 | −7 | 0 |

^{Note)}
In Comp. Ex. 2-3, measurement could not be carried out because coating strength was low and thus scratches were generated during evaluation of electromagnetic characteristics.

Evaluation Results

The above evaluation of electromagnetic characteristics was conducted for linear recording densities of 100 kfci, 200 kfci, 300 kfci, and 400 kfci. It is possible to reproduce with high sensitivity the signals recorded at these linear recording densities with high sensitivity MR heads such as GMR heads and the AMR heads used in the evaluation of electromagnetic characteristics, for example. Thus, a high S/N ratio can be obtained during high-density recording when it is possible to inhibit the decrease in output and the increase in noise due to the magnetic tape.

Accordingly, as set forth above, to inhibit the drop in output and the increase in noise due to the medium, the thickness of the magnetic layer in the magnetic recording medium in the present invention is set to within a range of 10 to 80 μm, Sdc/Sac is set to within a range of 0.8 to 2.0, and Mrδ is set to equal to or greater than 1 mA but less than 5 mA. As indicated in Tables 1 and 2, the magnetic tapes of the Examples having a magnetic layer thickness, Sdc/Sac, and Mrδ within the above-stated ranges all exhibited better electromagnetic characteristics than the magnetic tapes of the comparative examples.

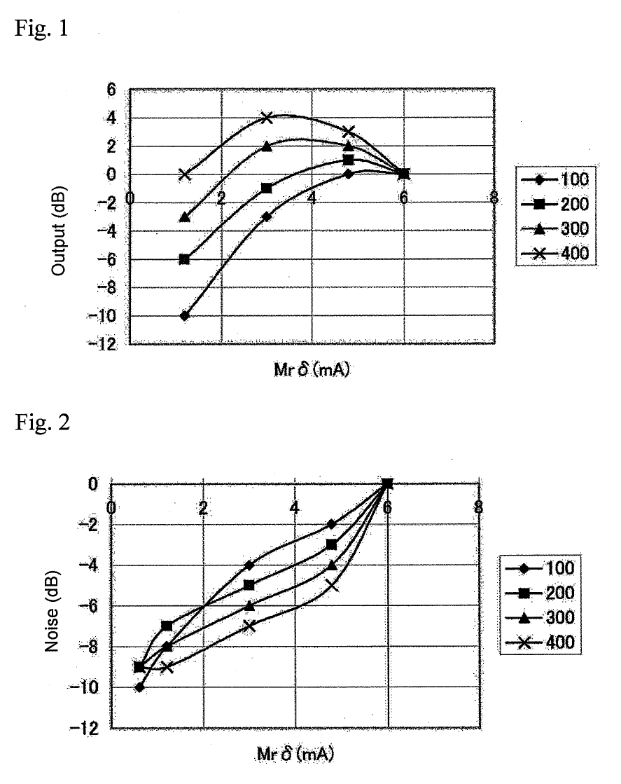

The obtaining of excellent electromagnetic characteristics in the high-density recording region in particular by employing an Mrδ of equal to or greater than 1 mA but less than 5 mA in a magnetic recording medium satisfying the above-stated ranges for the magnetic layer thickness and Sdc/Sac will be described next based on FIGS. 1 to 3.

FIGS. 1 to 3 are plots of the relations between the electromagnetic characteristic evaluation results and Mrδ for Examples 1-1 to 1-3 (Mrδ=1.2 to 4.8 mA), Comparative Example 1-1 (Mrδ=6 mA), and Comparative Example 1-3 (Mrδ=9.6 mA) at linear recording densities of 100 kfci, 200 kfci, 300 kfci, and 400 kfci.

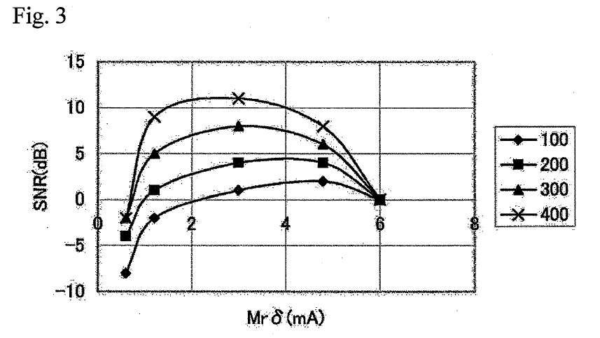

In the Mrδ and output in FIG. 1, Mrδ peaked at 5 to 6 mA at a linear recording density of 100 kfci, Once 100 kfci was exceeded, Mrδ peaked at less than 5 mA. FIG. 2 shows a reduction in noise as well as in Mrδ. As a result, as shown in FIG. 3, it proved possible to ensure a high S/N ratio at an Mrδ of equal to or greater than 1 mA but less than 5 mA.

Based on the above results, it will be understood that suppressing the Mrδ value to less than 5 mA effectively enhances the S/N ratio as the higher the linear recording density becomes.

The magnetic recording medium of the present invention is suitably employed in magnetic recording and reproduction systems in which signals are reproduced with highly sensitive MR heads.

### BRIEF DESCRIPTION OF THE DRAWINGS

[FIG. 1] It shows the relation between Mrδ and output at linear recording densities of 100 kfci, 200 kfci, 300 kfci, and 400 kfci.

[FIG. 2] It shows the relation between Mrδ and noise at linear recording densities of 100 kfci, 200 kfci, 300 kfci, and 400 kfci.

[FIG. 3] It shows the relation between Mrδ and the S/N ratio at linear recording densities of 100 kfci, 200 kfci, 300 kfci, and 400 kfci.

1. A magnetic recording medium comprising a magnetic layer comprising a ferromagnetic powder and a binder on a nonmagnetic support, wherein
the magnetic layer has a thickness δ ranging from 10 to 80 nm,
a product, Mrδ, of a residual magnetization Mr of the magnetic layer and the thickness S of the magnetic layer is equal to or greater than 1 mA but less than 5 mA, and
a ratio, Sdc/Sac, of an average area Sdc of magnetic clusters in a DC demagnetized state to an average area Sac of magnetic clusters in an AC demagnetized state as measured by a magnetic force microscope, MFM, ranges from 0.8 to 2.0.

2. The magnetic recording medium according to claim 1, wherein the ferromagnetic powder is a hexagonal ferrite powder.

3. The magnetic recording medium according to claim 2, wherein the hexagonal ferrite powder has an average plate diameter ranging from 10 to 45 nm and an average plate ratio ranging from 1.5 to 4.5.

4. The magnetic recording medium according to claim 1, wherein the ferromagnetic powder is an iron nitride powder.

5. The magnetic recording medium according to claim 4, wherein the iron nitride powder has an average particle diameter ranging from 5 to 30 nm.

6. The magnetic recording medium according to claim 1, which is employed in a magnetic signal reproduction system employing a giant magnetoresistive magnetic head as a reproduction head.

7. A magnetic signal reproduction system, comprising:
the magnetic recording medium according to claim 1, and a reproduction head.

8. The magnetic signal reproduction system according to claim 7, wherein the reproduction head is a giant magnetoresistive magnetic head.

9. A magnetic signal reproduction method, reproducing magnetic signals that have been recorded on the magnetic recording medium according to claim 1 with a reproduction head.

10. The magnetic signal reproduction method according to claim 9, wherein the reproduction head is a giant magnetoresistive magnetic head.
